(19) United States
(12) Patent Application Publication
(10) Pub. No.: US 2010/0031159 A1
(43) Pub. Date: Feb. 4, 2010

(54) SYSTEMS, METHODS, AND INTERFACES FOR PUBLISHING AND DISTRIBUTING LEGAL EDUCATIONAL MATERIALS

(76) Inventor: Justin Hummel, Cottage Grove, MN (US)

Correspondence Address: SCHWEGMAN, LUNDBERG & WOESSNER, P.A., P.O. BOX 2938, MINNEAPOLIS, MN, 55402, US

(21) Appl. No.: 12/495,570

(22) Filed: Jun. 30, 2009

Related U.S. Application Data
(60) Provisional application No. 61/133,615, filed on Jun. 30, 2008.
(60) Provisional application No. 61/191,676, filed on Sep. 11, 2008.

(51) Int. Cl. G06F 3/01

(52) U.S. Cl. 715/741

(57) ABSTRACT

To address this and/or other needs, the present inventor devised, among other things, an online educational materials publication and distribution system and method. One exemplary embodiment provides an educational publishing website that functions as a virtual community and marketplace where law professors can connect with one another and share and sell electronic, legal education materials to law faculty, staff, and students. The website not only enables law professors to self publish the materials to the entire law school community, but also serves as an alternative channel for legal publishers to sell and otherwise distribute branded and other materials to the law school market.

### RELATED APPLICATIONS

The present applications claims priority to U.S. Provisional Patent Applications 61/133,615 and 61/191,676, which were filed respectively on Jun. 30, 2008 and Sep. 11, 2008. Both of these applications are incorporated herein by reference.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright © 2008, West Services Inc.

### TECHNICAL FIELD

Various embodiments of the present invention concerns electronic publication and distribution of educational materials, particularly legal educational materials.

### BACKGROUND

The present inventor recognized that the current system of distributing educational materials is highly limited, particularly for educational authors who desire to self-publish course materials for a broad group of students. For example, using The West Education Network Currently (TWEN®)), a law professor can create his own materials and upload them to a TWEN® class for free student usage. However, access to these materials is generally limited to the students within a single course instance. The TWEN® system does not make it easy for a professor to post something once and allow larger community access.

Accordingly, the present inventor has recognized an unmet need for better ways of facilitating online, self-publishing and distribution of course materials.

### SUMMARY

To address this and/or other needs, the present inventor devised, among other things, an online educational materials publication and distribution system and method. One exemplary embodiment provides an educational publishing website that functions as a virtual community and marketplace where law professors can connect with one another and share and sell electronic, legal education materials to law faculty, staff, and students. The website not only enables law professors to self publish the materials to the entire law school community, but also serves as an alternative channel for legal publishers to sell and otherwise distribute branded and other materials to the law school market.

In some embodiments, the website functions as free-standing e-commerce site, distinct from, but associated with a website, such as The West Educational Network (lawschool.westlaw.com). Some embodiments also allows law students to donate and/or sell educational materials. In addition, some embodiments allow law practitioners to buy and sell materials through the educational publishing website.

### BRIEF DESCRIPTION OF DRAWINGS

FIGS. 1-34 are facsimiles of graphical user interfaces for use in electronically publishing and distributing legal educational materials.

FIG. 35 is a block diagram of an exemplary system used in conjunction with the graphical user interfaces of FIGS. 1-34.

### DETAILED DESCRIPTION OF EXEMPLARY EMBODIMENTS

This description, which incorporates the drawings and appended claims, describes one or more specific embodiments of an invention. These embodiments, offered not to limit but only to exemplify and teach the invention, are shown and described in sufficient detail to enable those skilled in the art to implement or practice the invention. Thus, where appropriate to avoid obscuring the invention, the description may omit certain information known to those of skill in the art.

### System Overview

The legal education website encompasses a content management system which not only has user-provided files or but also proprietary West® files as well. West® provided files include articles, literature, forms, casebooks, secondary sources, study aids and any other proprietary or non-proprietary data that West® has permissions for. As for the user-provided files, these files can have several uses including personal, scholastic, and/or academic.

In addition to the content management system, the user has the ability to publish and upload his or her work to the website. For instance, the user is a professor that has authored some papers over the summer and wants his students to use his material before it publishes in paper. The self-publishing feature on the website allows that professor to upload and publish various files he or she through a closed and secured mechanism. Once the professor (more generally author) has completed the uploading and publishing, students can purchase this content through an e-commerce transaction. The professor who publishes to the educational publishing website can either offer the materials for free or for sale. In the free case, any educational publishing website user can download the materials without cost. In the for sale case, the professor sets a price that any educational publishing website user-buyer must pay for the materials. Sales are transacted through the educational publishing website using standard, online payment means and mechanisms, with the website owner, for instance earning a percentage of all sales.

Law school students can buy materials on the educational publishing website. Therefore, a professor can adopt and require the educational publishing website materials, whether published by her or someone else, for class use by her students who acquire the materials through the educational publishing website.

In some embodiments of the present invention, the materials can be published for use by other law professors or law students. Therefore a professor can prepare and publish materials for use: by other faculty for their personal purposes; by other faculty for their students, including other faculty adopting educational publishing website materials for use in the classroom or as student aids; or by law students. In some instances, the website is closed and secure, enabling a professor to implement, organize and maintain a classroom management system that encompasses all classroom materials including quizzes, assignments, test, curriculum, grading sheets, etc.

Some legal education websites only allow personal use and contact only users within the university he or she resides. Embodiments of the present invention provide a public component that allows professors to contact anyone that is a user within the website regardless of university affiliation. The website also provides a community feature that revolves around the content that the author has viewed, authored, selected, and gathered. This feature allows an author to collaborate with other authors, team teach (group page) with their own content uploaded, allow comments and discussions through various medias (i.e. email, IM, chat rooms, blogs).

Buyers and Adopters

Buyers & adopters, which, for the exemplary embodiment, include people acquiring donated materials, access the website through links on lawschool.westlaw.com or by a reference (posting) link on an educational network, such as TWEN®. A buyer is someone that has to purchase the content or has access to free content through TWEN® or a professor's website. An adopter is a professor that is viewing or using the material without distribution to students.

The adopter can sort and browse materials in terms of the standard, identifying information that is required for every posting to the website. The adopter can also search, with or without prior sorting, using advanced search methods. The site in some embodiments indicates the “top picks” and “recent additions” by different genre. The genre includes subject matter; form (document; powerpoint; video, etc.); and purpose (classroom material; student aid; etc.). The educational publishing site remembers the kinds of materials an adopter acquires and send her notices when similar, new materials are added. Result lists also suggest related materials based on what a user search, search history, purchase history, academic specialization (e.g., intellectual property law or criminal law) or even current or past classes. Some embodiments suggests materials based on academic performance within a given class, presenting students with less than desirable performances on exams or other evaluation instruments, special learning aids or other materials.

The adopter can later post her review of the materials. Adopter reviews are included in the description of individual items available on the site that a person sees before acquiring the materials.

Relationship with TWEN®

Every TWEN® (The West Education Network) page has a prominent link to the educational publishing website, for example as part of the navigation bar at the top of the law school page. Additionally, the link replaces the current OFD mechanism inside the posting pages in TWEN®.

A professor who from his or her TWEN® class, posts materials to the TWEN® class, has the option to simultaneously publish the same materials to the educational publishing website.

A professor who finds useful materials can designate, when acquiring the materials on the educational publishing website, that a copy be added at a certain place within a TWEN® class. The site accommodates this designation whenever it is consistent with the materials' licenses (for example, materials donated for public use).

If a professor finds materials for sale on the educational publishing website that he or she wants the students to buy for class, she can designate this adoption, and students are prompted to purchase the materials when they log in to TWEN®. (In some embodiments, the professor or affiliated educational institution may automatically receive a commission for sales to students as directed by the professor.) A preferred embodiment makes the request to purchase the materials the first time they log into TWEN®. Yet another embodiment allows the materials added subsequent to adding the course, a prompt for purchase upon accessing the link to the material.

Personal Pages

Through lawschool.westlaw.com, every professor (whether or not he or she uses TWEN®) can create a personal (though standardized) web page for professional purposes that includes (when allowed) the branding associated with the professor's school.

The page allows publishing the usual information that is included in faculty biographies on law school websites. However, some embodiments of the present invention have the advantages of being easily created by the professor, are usually richer in content, and are effortlessly updated by the professor. The website allows the professor to include more information than the usual, law school web page allows including functions and purposes for teaching and research that are beyond the capabilities of typical, law school websites.

Still other embodiments include “teaching functions” on the personal page which allows for the distribution of materials outside of TWEN® especially useful for the professor and students who does not use TWEN®. On the personal page, the professor can post recommendations for materials for the students and other visitors. Another embodiment allows the professor to host a blog or the like directly from, and as a part of, the personal page site. These personal teaching pages could limit access to materials based on password entry as well as purchase entry (pay to gain access). Personal page materials that require payment or registration do not open until the student or site visitor has registered or paid for access.

The personal page also allows direct posting to and searching of the educational publishing website. Additionally, when appropriate and allowed, copies of materials published on the site can be allowed to a professor's personal page site. In essence the personal page is an extension of the website with limited access and customized branding. The personal pages allow the professor the option of including many features such as: links to TWEN® classes; textbook resources; textbook selection; teaching resources; documents library; RSS feeds for news, blogs, and current awareness; and Westlaw® research. Also, to the extent that TWEN® offers additional features and functions, personal pages could be used to make certain of these features and functions available to faculty who are not TWEN® users.

Ideally students are allowed to create personal pages with features and functions designed for them. This embodiment allows the students the ability to create rich-featured, student personal pages with the right to publish through the educational publishing website.

### Exemplary Graphical User Interfaces

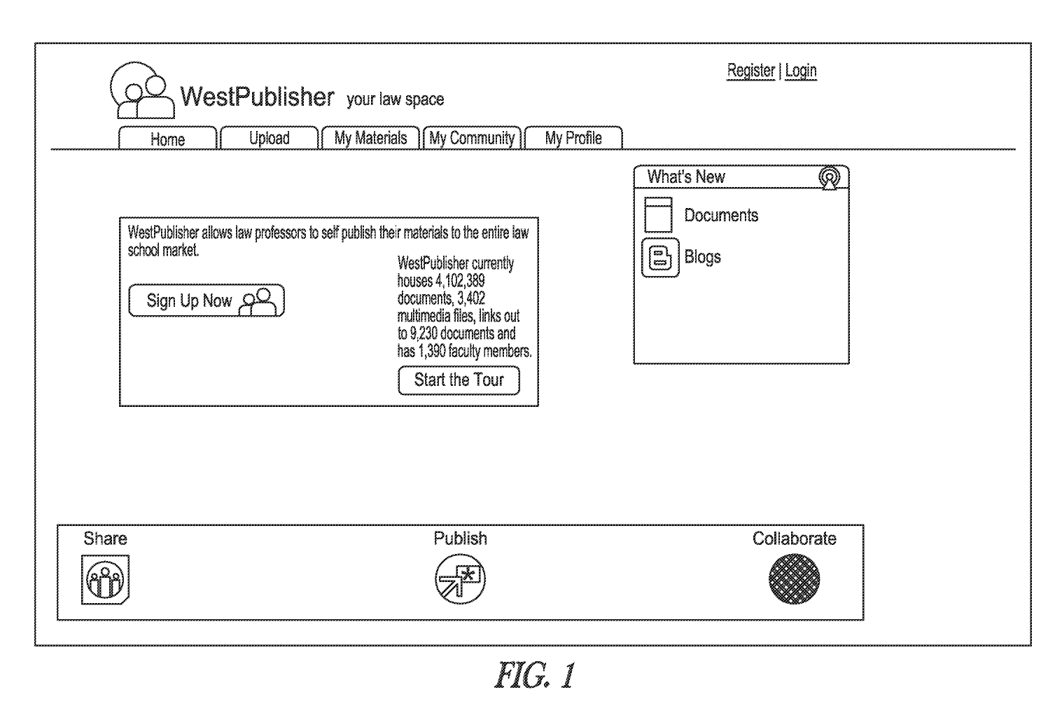

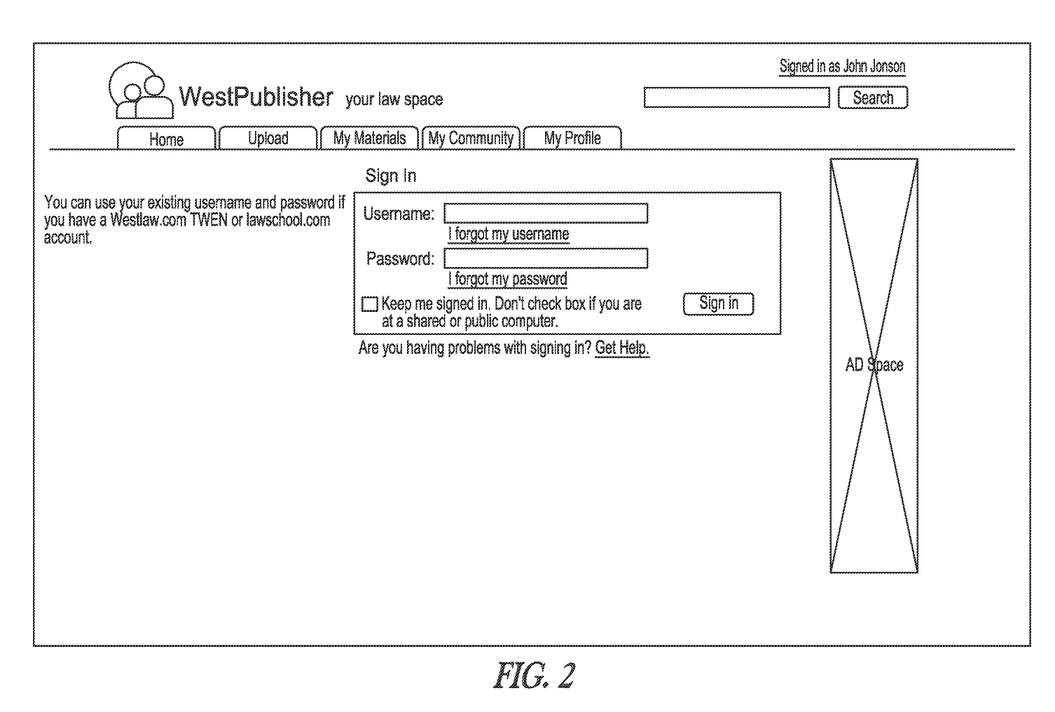

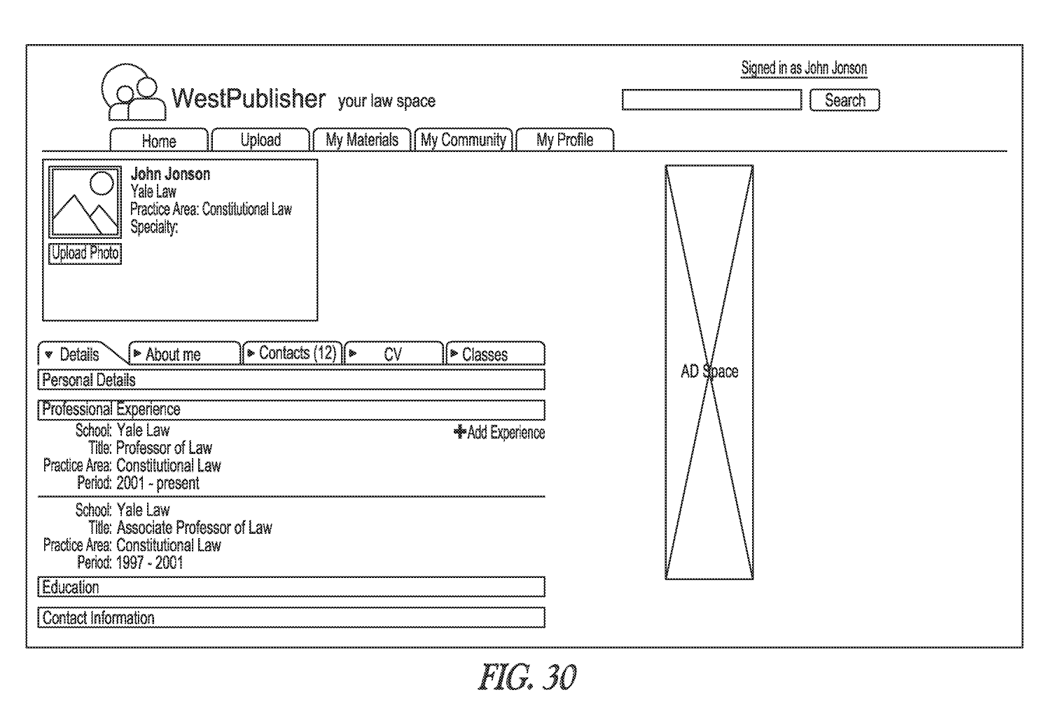

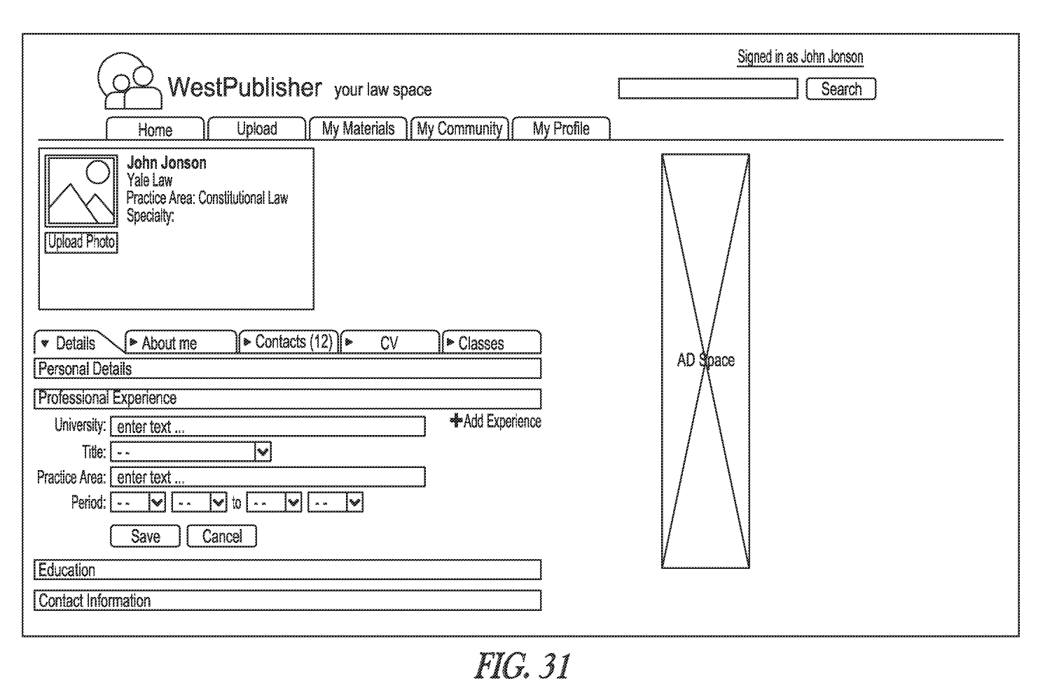

FIGS. 1-34 show various graphical user interface screens for electronic publication and distribution of legal educational materials via a website on local or wide-area network, such as the Internet. However, other embodiments can be tailored for other purposes including other educational purposes (medical school, high school, colleges, K-12, home schooling), law firms, or any establishment that wants to not only attract and retain members, but also promote sharing of information and materials with other members and/or non-members. In the event that the user is underage (for example, a child in K-12 that has to purchase materials for a class), the appropriate mechanisms are in place to ask if the user is under 18. If they underage, a message appears notifying the user that a parent/guardian needs to handle the transaction.

FIG. 1 displays a home page for allowing a user to sign up for a system for publishing, sharing and selling legal educational materials. This interface may also include a feature that guides the user through a tour of the system. Another feature shows the user what documents and/or blogs are new to the webpage.

FIG. 2 illustrates the sign in page for the exemplary embodiment. This sign-in may be unique to the webpage or it may be the same sign-in from another account such as an existing username and password from the user's Westlaw®, TWEN® or lawschool.com account. Throughout the various web pages within some embodiments of the present invention, advertisements for various products may be displayed where vacant space may otherwise have been.

The educational publishing website has individual profiles which are created during the time of registration. These profiles help the system identify user type, designate user access, market distribution, system notices and allow users to accurately identify colleagues, friends and content users. Once the user has entered a successful login combination, users need to register to create a profile.

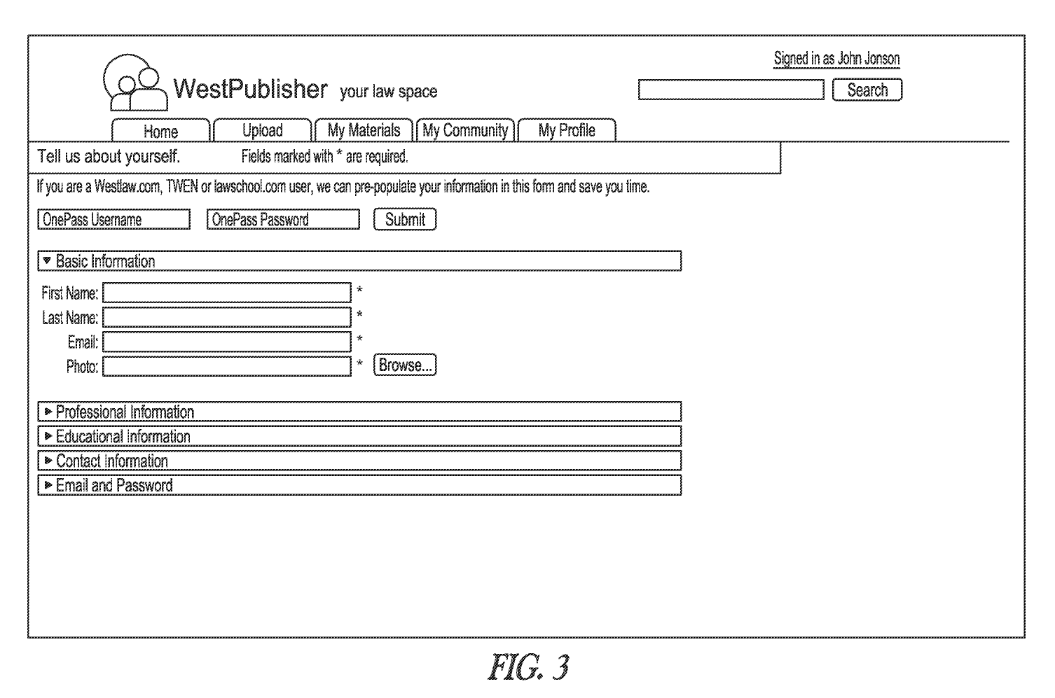

FIG. 3 shows the initial register fields of information for the exemplary embodiment. Examples fields include basic information, professional information, educational information, contact information, and email and password information. Certain fields are required if the user wants to successfully complete initial registration. These fields are marked with an “*” or otherwise clearly identified. Users can also add tags to their profiles which helps categorize them in the community. These tags are appended to their profiles and bring up the user in profile searches. If user has one-pass information, the information connected to this pass is pre-populated into the appropriate fields. After the user has populated at least the required fields, a confirmation message is sent to the email address given by the user.

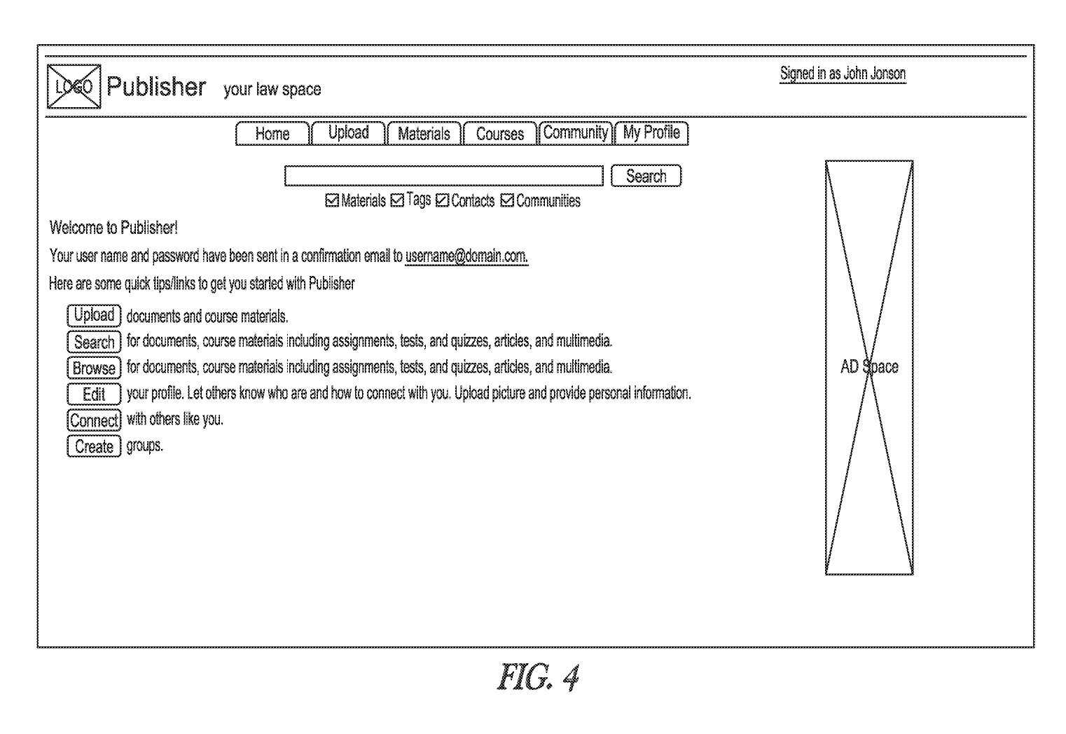

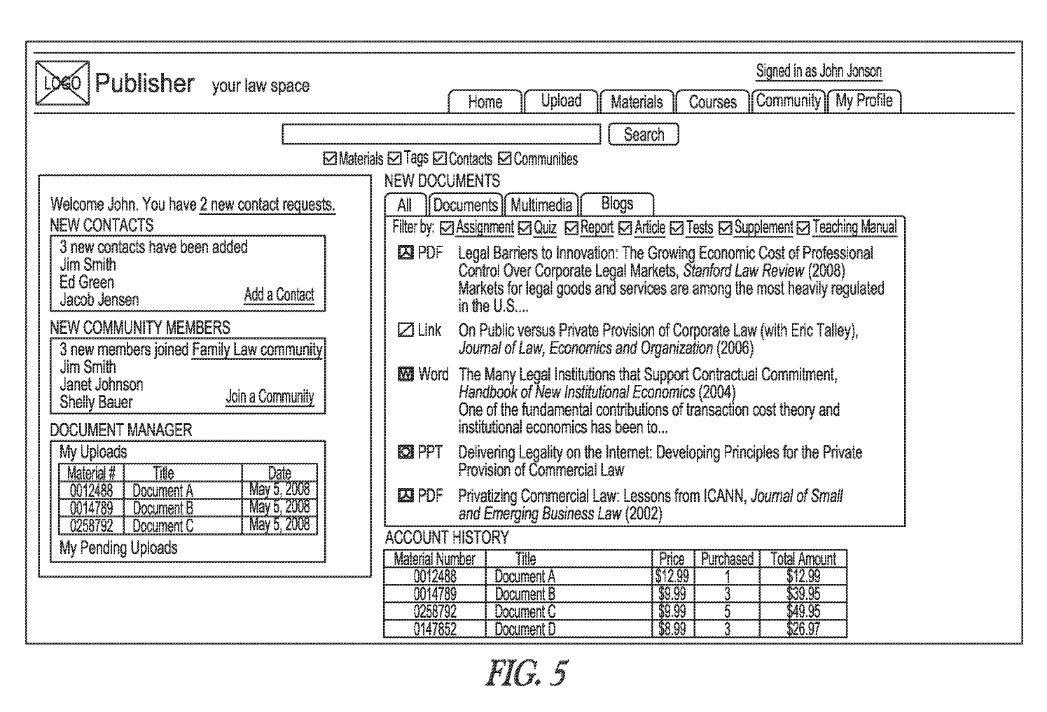

FIG. 4 displays some quick tips/links to get the user acquainted with the interface and the system. These tips/links include uploading documents and/or course materials, keyword searching for documents/course materials, browsing documents/course materials by category, editing the user profile, connecting with other users, and creating groups.

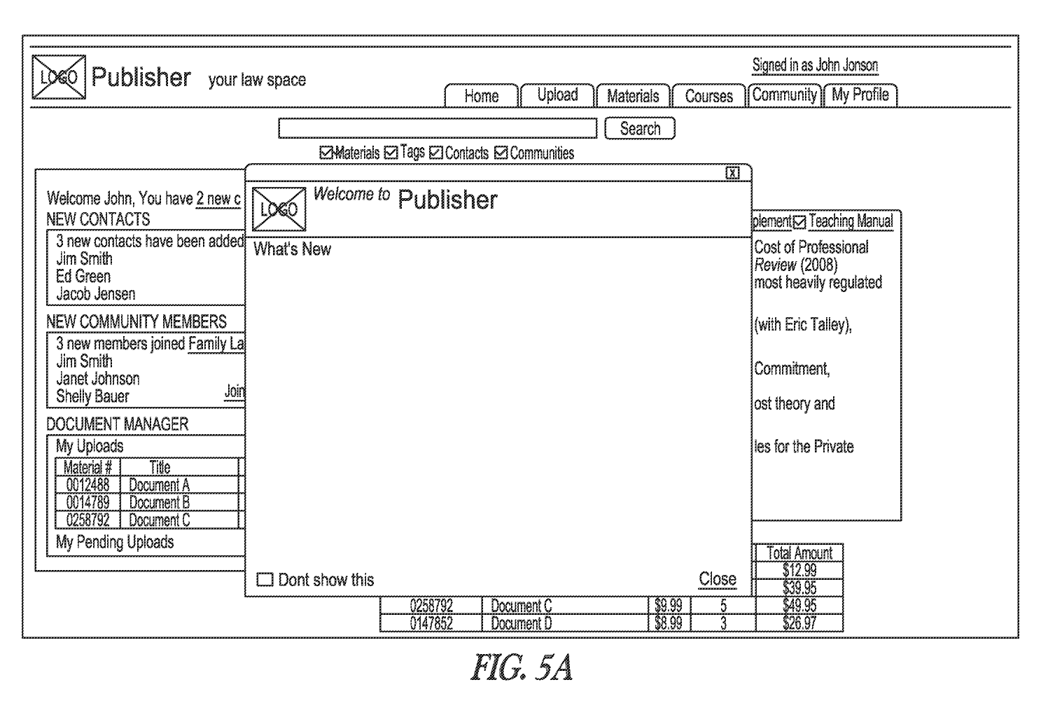

FIGS. 5a and 5 show exemplary displays of the user's homepage. FIG. 5a illustrates a pop-window that notifies the user of all the information pertaining to the user's content. In FIG. 5, the homepage shows several items to the user including account history, new contacts, new members joining a community, and new documents added to a specific subject area. Also included within the homepage are contact requests and a document manager section. Additionally, various navigational tabs (Home, Upload, My Materials, My Community, My Profile) and a search box are located near the top of each webpage. Directly underneath the search box within the homepage are checkboxes, allowing the user the flexibility to choose what items he or she wants to search. If the user has more selective criteria than the type of documents searched, an “Advanced Search” link is available to the right of the initial search box. Selecting this link invokes display of an advance search interface.

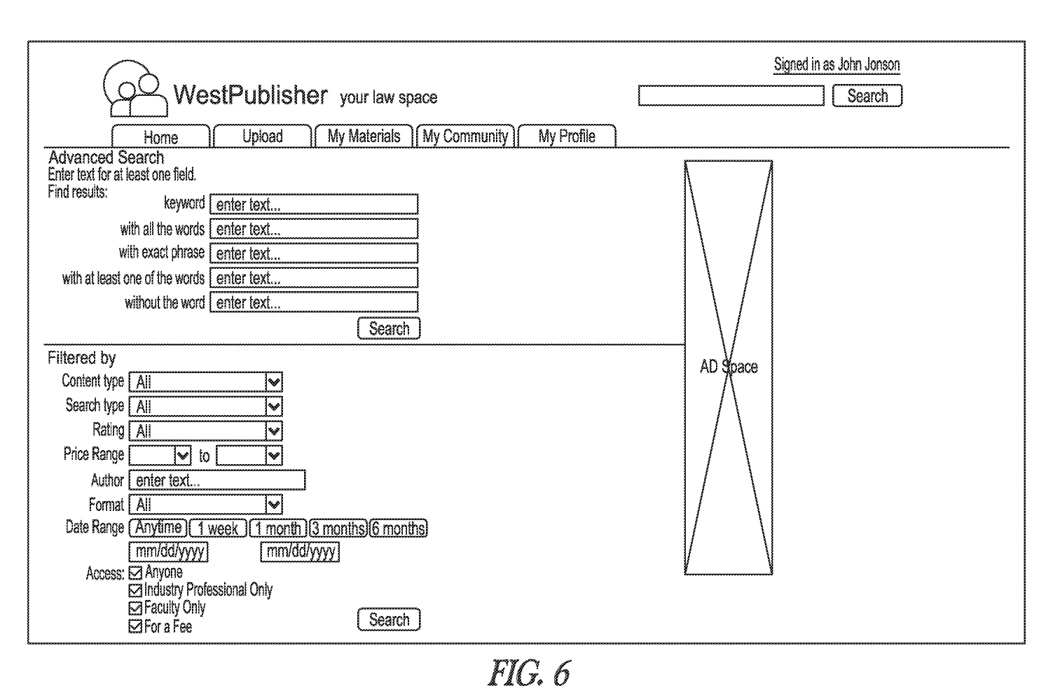

FIG. 6 shows an exemplary advance search interface. Using the advanced search interface, a user can narrow his or her criteria by advanced keyword searching and/or several filters including price, date, access, content type, search type and author.

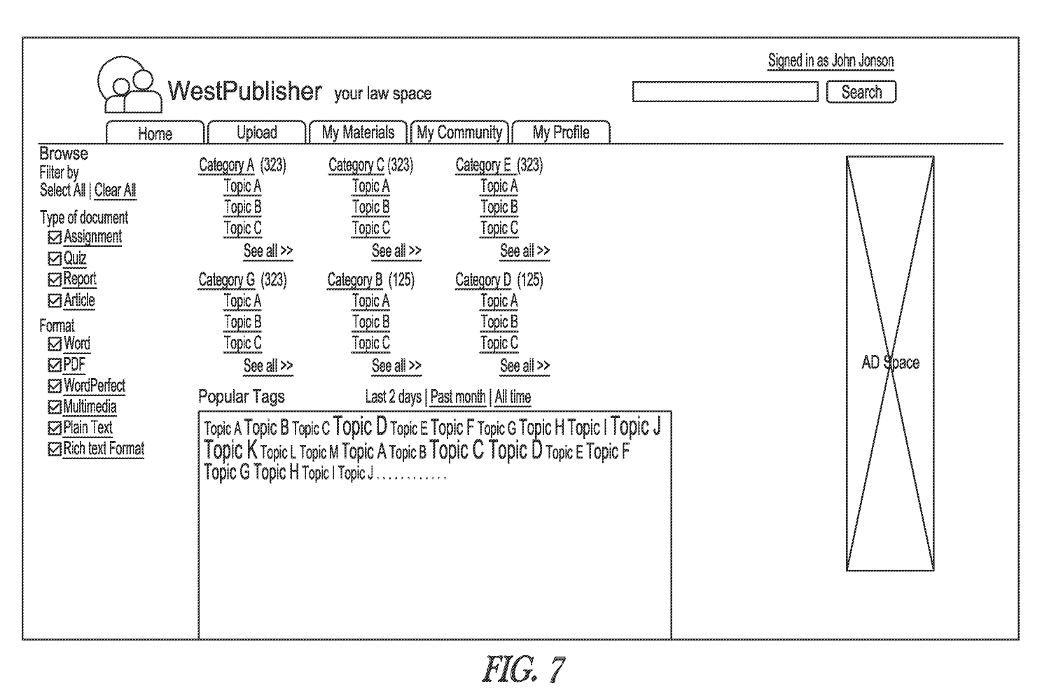

If the user chooses to search by category, FIG. 7 shows an exemplary legal category selection interface with various topics linked underneath each category. Also illustrated is a box where popular tags with the webpage are identified. In this example, the more popular tags have larger font and are bolded to distinguish from other tags. Some embodiments may use color coding of the fonts to distinguish popularity.

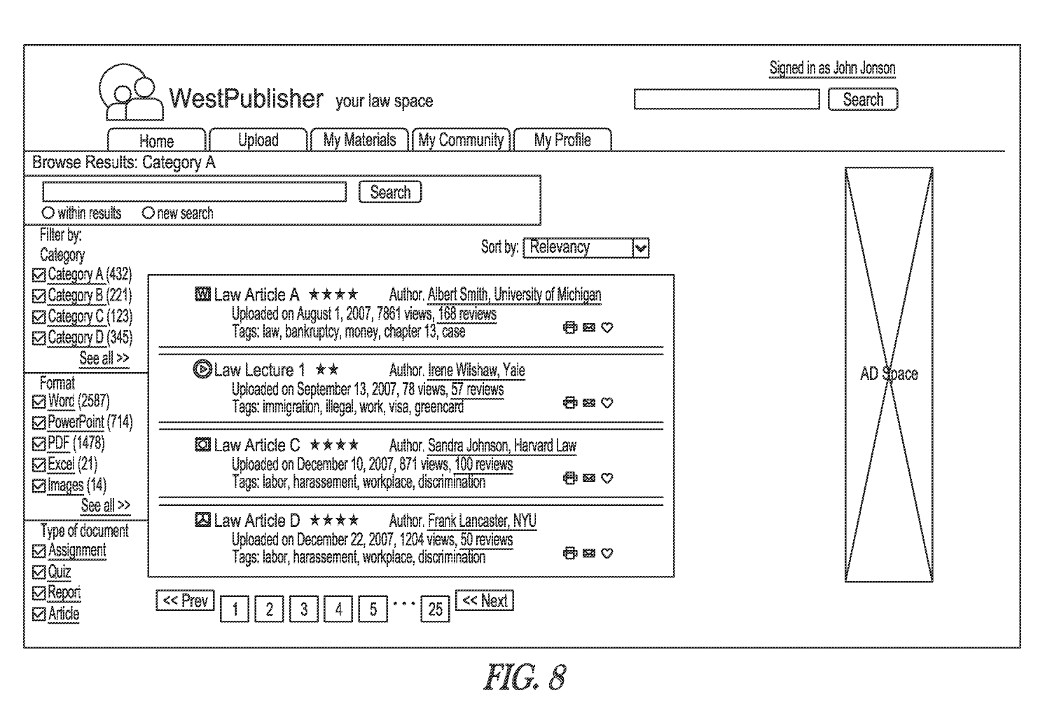

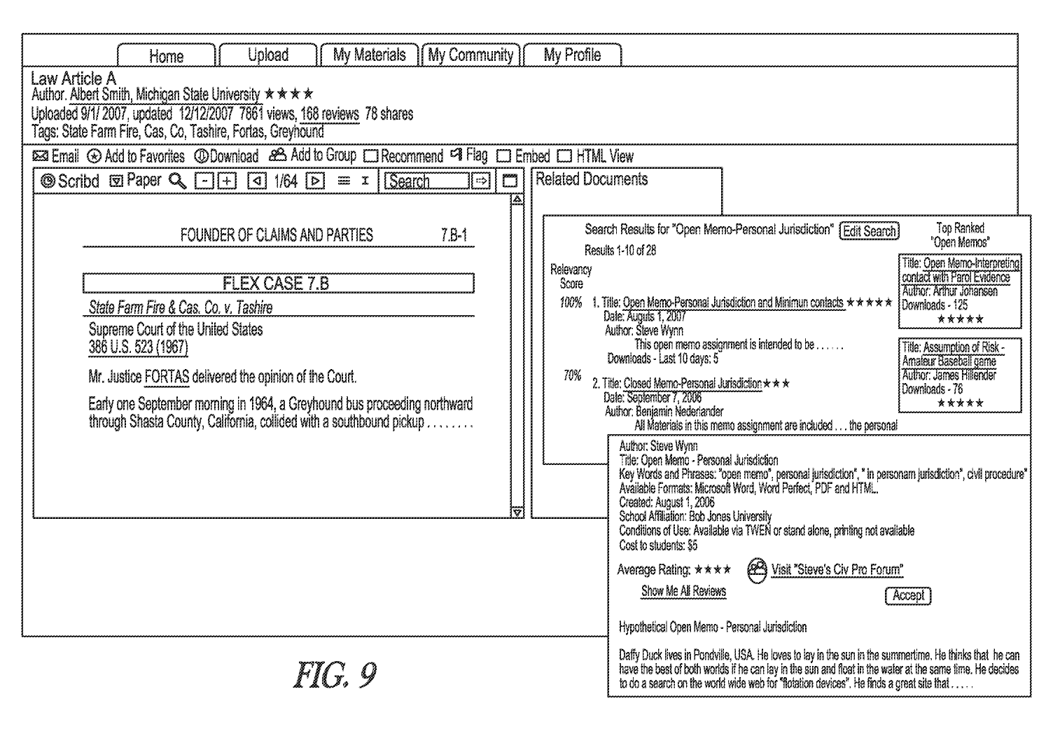

FIG. 8 shows the interface that the user sees if he or she selects “Category A” from the display link and further selects one of the materials to read. When the user selects a material to read, such as law article A, a multimedia and application player is executed (either as plug-in or standalone) to allow for delivery and display of the content to the user as shown in FIG. 9. A multimedia and application player permits the user to work with various mediums without having to install all the necessary applications. The interface, however, only allows the user to edit or copy if the user has the appropriate permissions. After selecting to adopt materials, or before paying for materials offered for sale (if a student), the adopter/buyer must agree to whatever universal, standard terms of use that administrator imposes and also whatever additional, peculiar terms are required by the person who posted the materials. These terms are part of the identifying information required that must be supplied whenever materials are posted on the site.

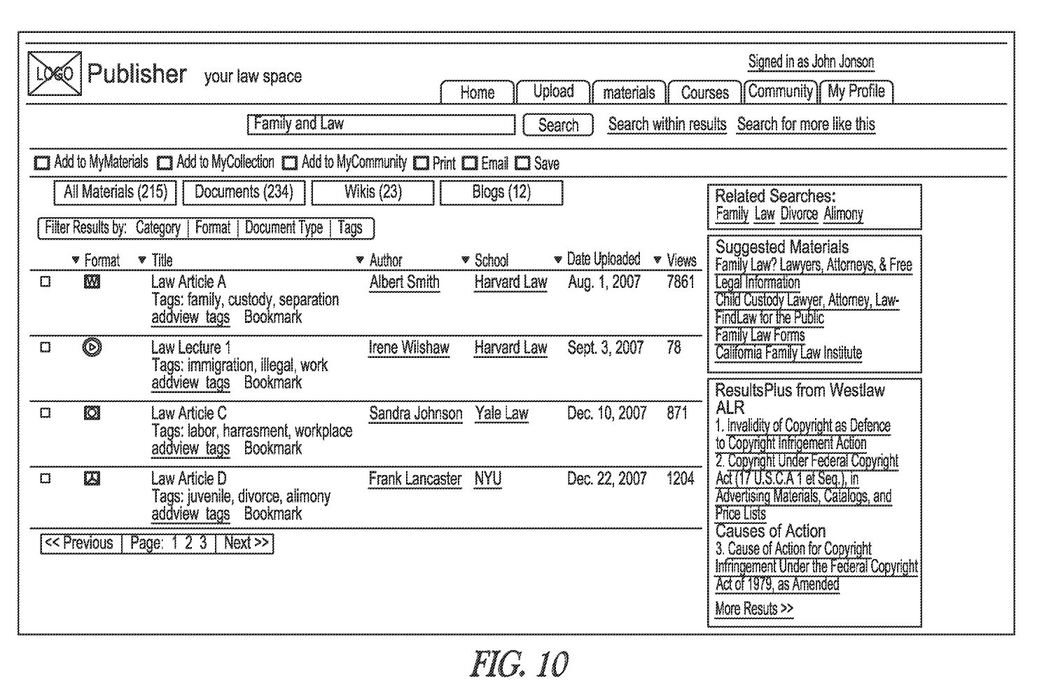

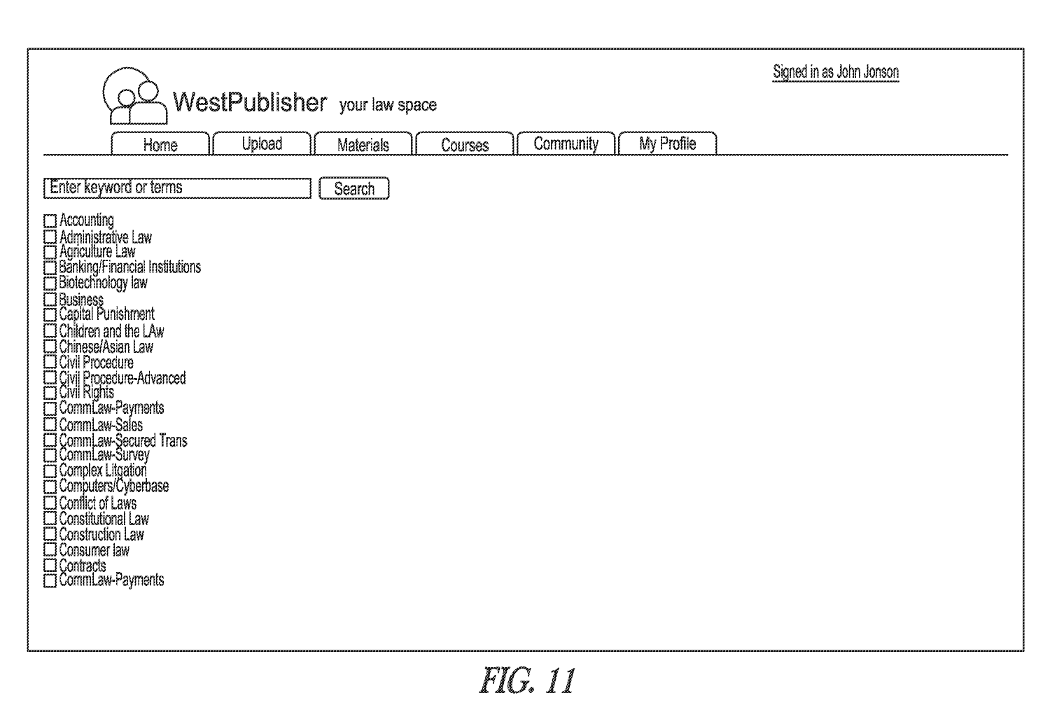

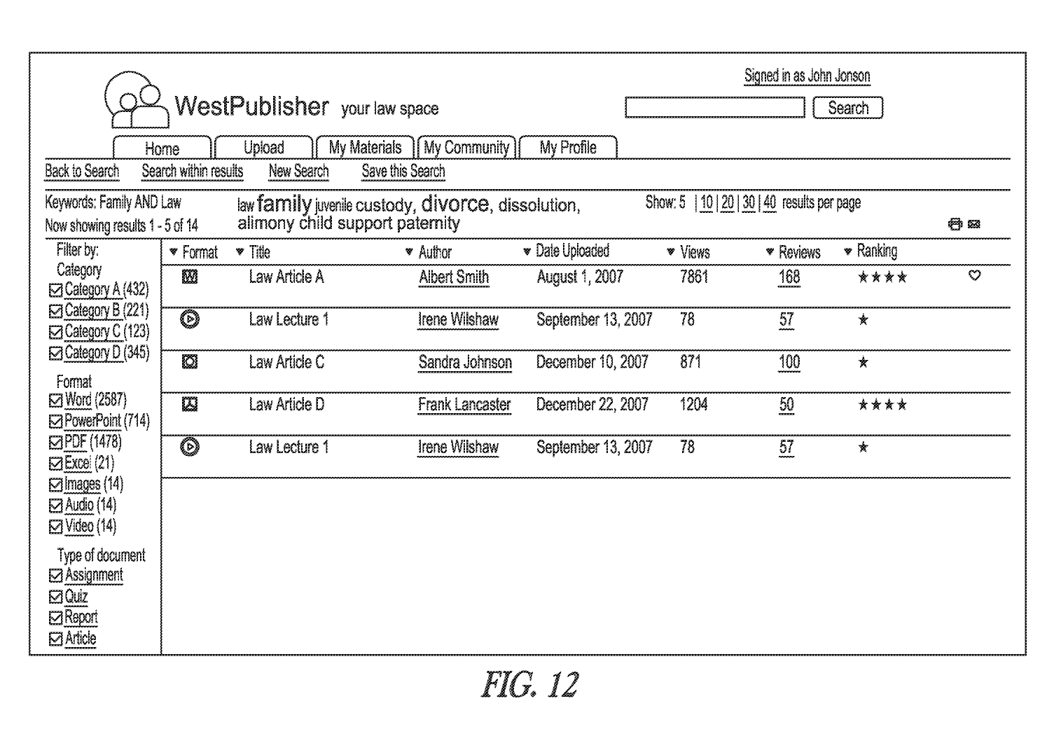

FIG. 10 shows an exemplary search results interface presented in response to a user searching by keyword, such as “family and law.” A results list would appear in the main display of the screen. Other options allow the user to filter by category, format, or type of document. Additional options, various other information is populated on the screen that somehow relate to the user's query such as ResultsPlus®, suggested materials, related searches, tags, etc. FIG. 11 shows another searching interface that allows the user to enter one or more keywords and to select a topic checkbox to narrow his or her search. FIG. 12 shows another exemplary search results interface. Notably, this interface includes a filtering section (left hand side) which allows filtering of the displayed search results by category, format, and document or file type.

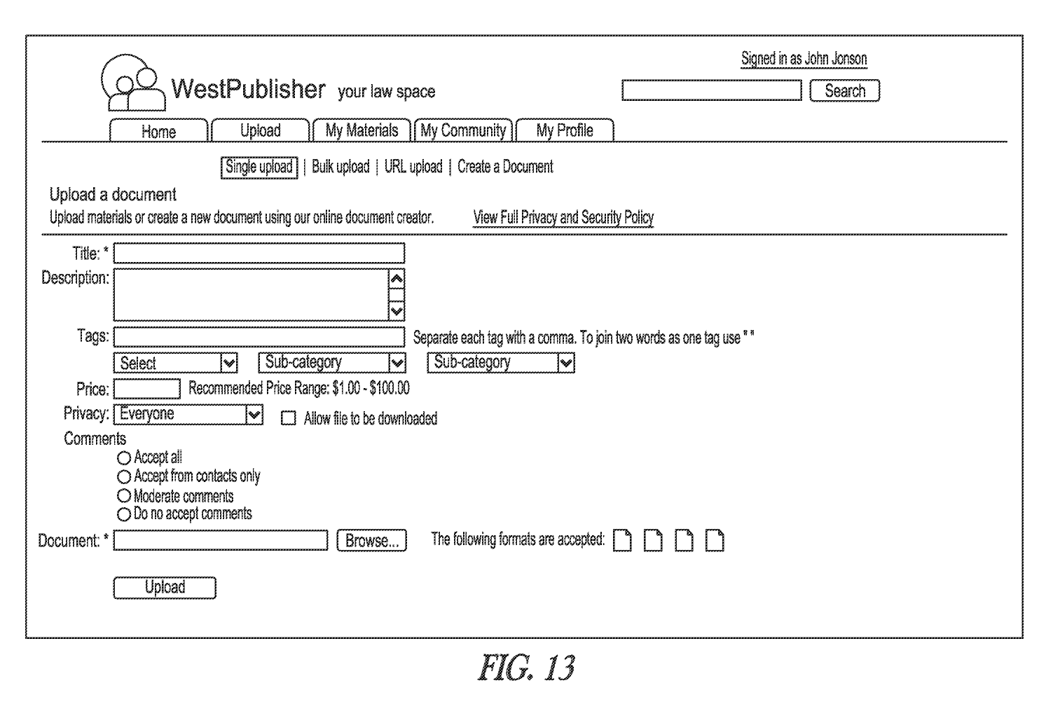

FIG. 13 shows an exemplary document upload interface, which is displayed in response to the user selecting the “Upload” navigational tab. The figure shows the user must populate or at least select the document and the title. Most types of files can be published including: word processing documents, Excel spreadsheets, text files, video, audio, quizzes and quiz banks, pictures, and powerpoints. These files could be converted to HTML, PDFs, Flash-paper or some equivalent solution. This conversion allows for on-screen viewing and full-text searching. While multi-media files may not be searchable directly, their metadata can be. As the user selects the document, a notice may be provided telling the user only certain formats are acceptable. A privacy and security policy link is located within the webpage for the user to read at anytime. The user may also choose to populate additional information into the uploading screen including a brief description of the document, price, privacy drop-down box, subject category and sub-category drop-down boxes, comment criteria, and tags. A tag is a potentially relevant keyword or term associated with the document being uploaded. Each word is separated with a comma and phrases are joined by quotation marks. The number of tags allowed is decided by the system's restrictions. Although not illustrated, if the file is not authored by the user, a checkbox or other mechanism can be placed on this page establishing that the user has the proper authorization/permissions to publish the file. Once this information has been entered, user selects the “Upload” button near the bottom of the webpage. If the user has more than one file to upload, an additional button may be displayed to allow the user to continue to select additional files for uploading. The uploaded file can be stored on a hard drive, server or any other location that can handle the file capacity. The uploaded files are then displayed within the My Uploads in addition to the account history section on the homepage.

Every time a user posts anything, he or she must provide certain information that fully identifies him and also fully identifies the material and provides for the fullest classification, indexing, and searching of the materials, including searching by term and natural language. Based on this information, metadata is tied to files for search purposes. Especially for public materials, whether donated or for sale, success depends on very robust sorting and searching functions to identify quickly and reliably materials that meet a user's needs. Terms of use are pieces of the identifying information. The professor posting to TWEN® must designate whether the materials are public or private and whether the materials are donated or for sale. Especially important with respect to materials for sale are the pricing and the extent or range and duration of the license (including redistribution).

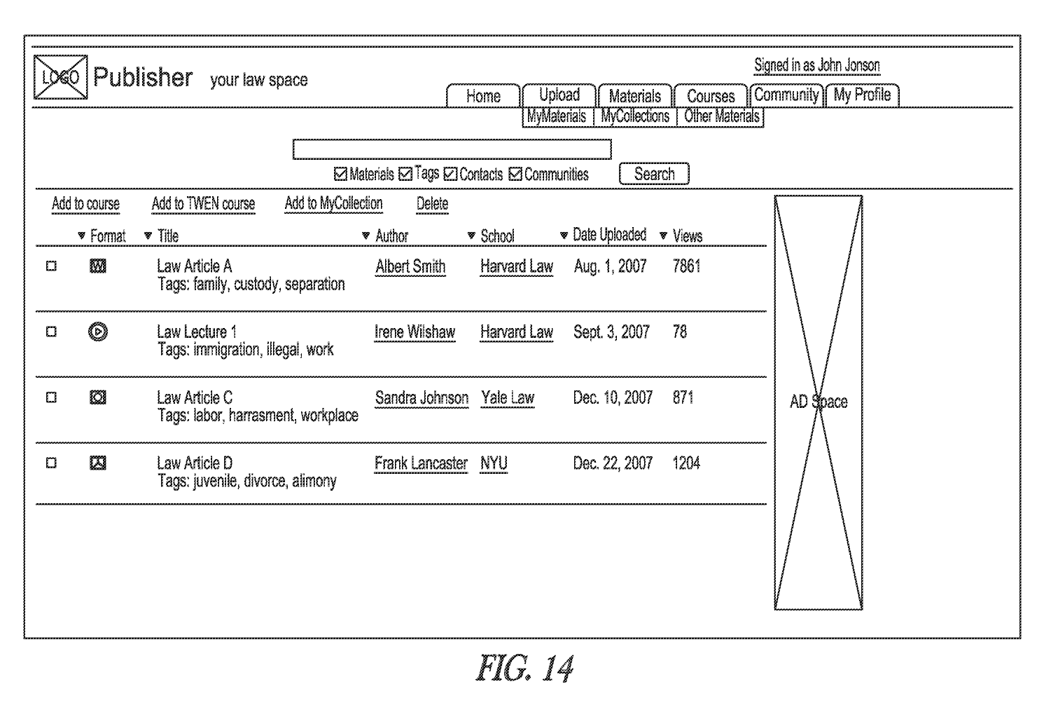

FIG. 14 shows a my-materials interface which is associated with My Materials tab. This interface includes a complete listing of all of the files that the logged in user has authored or is using for coursework. Each listing shows the title, document format, date/time uploaded, reviews, other user viewings, tags and any other relevant information. These documents may be selected by checking the box to the left of the title. After selecting the wanted documents, the user has several options including printing, emailing, deleting, adding to a course, adding to a TWEN® course, and adding to My Collections via selection an “Add to My Collections” link.

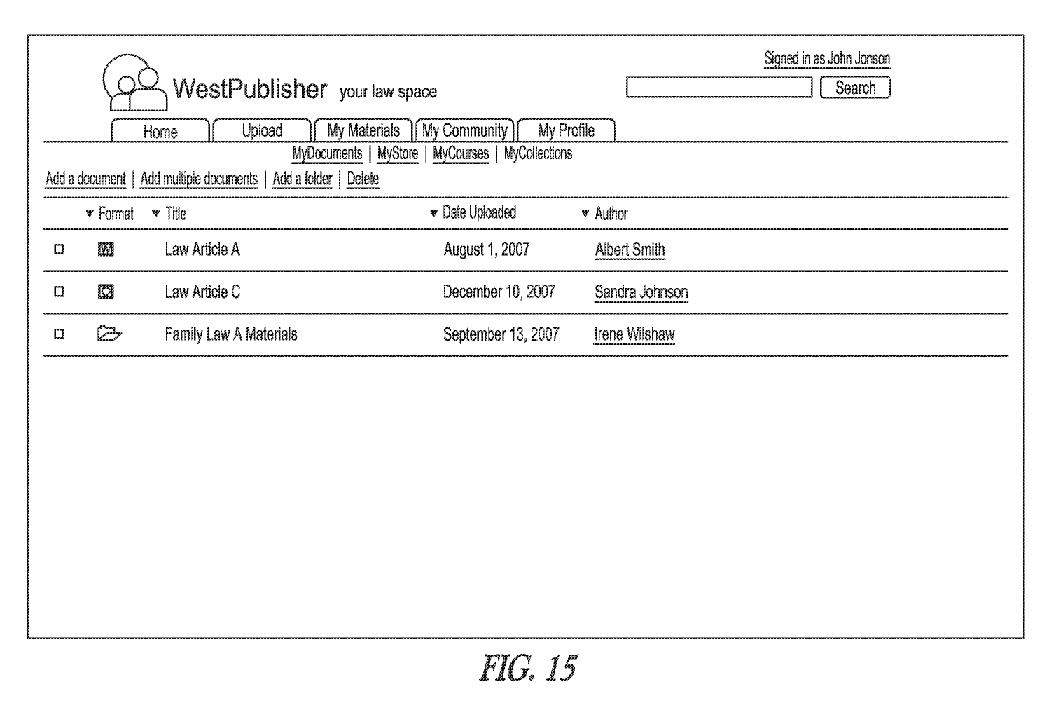

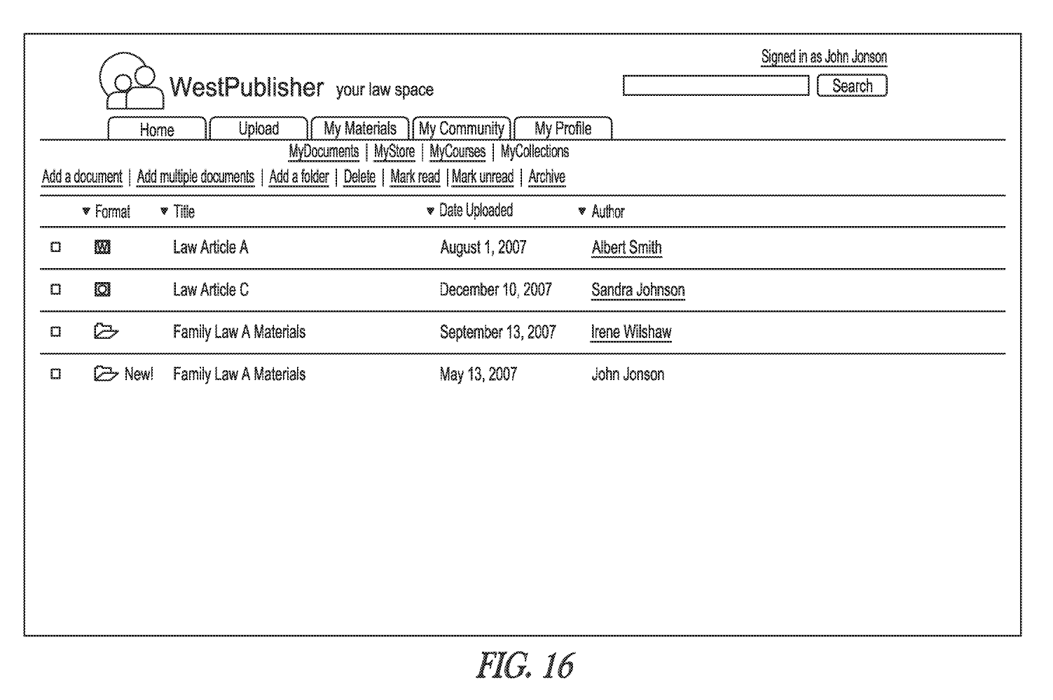

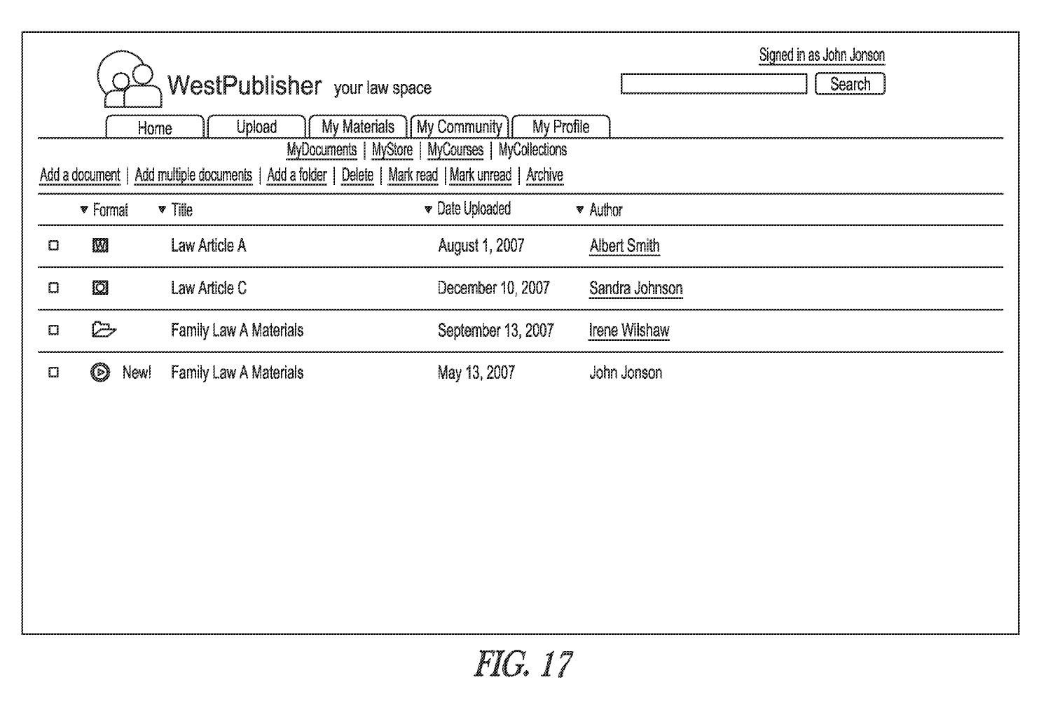

FIG. 15 shows an exemplary My Collections interface, which is displayed in response to selection of the My Collections tab in FIG. 14. The My Collections interface allows the user to organize all received materials not only the materials owned by the user. Folders and documentation can be added or deleted. FIG. 16 shows addition to a new folder labeled Family Law A to the My Collections interface. FIG. 17 shows the My Collections interface after addition of a new video labeled Family Law A. Materials listed on can be marked as read/unread or added/deleted by electing adjacent checkboxes and then selecting a delete, mark read, mark unread command link on the interface. Clicking on the My Courses link invokes display of a My Courses interface.

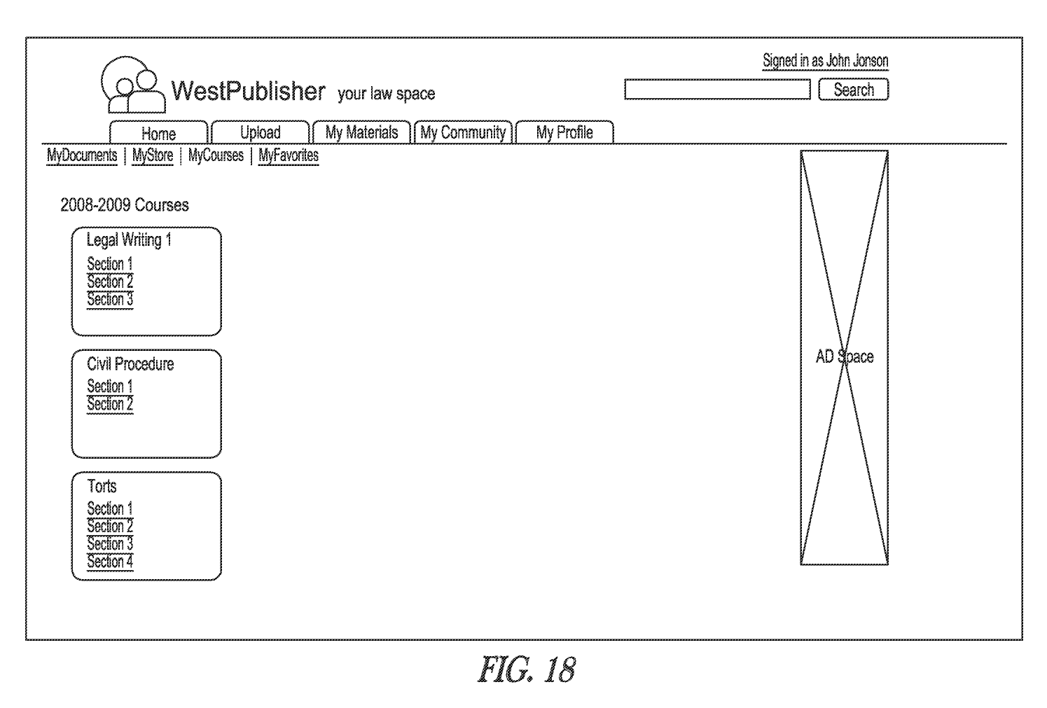

FIG. 18 shows an exemplary My Courses interface, which lists courses that the user is currently teaching and/or taking. (The user data for populating this interface is stored in a subscriber databases and/or accessed from a course database associated with an educational institution's database associated with the user. In the case of accessing the educational institution's database, the user data in the subscriber database may include access credentials, such as username and password, for transparently accessing the institutional database on the fly or in response to a signal that the course content information of the institutional database as been updated.) However, previous courses could remain on the webpage for a specified period of time.

The education publishing website is largely self filtered and self-regulated. And because it is largely self-regulated, an embodiment of the present invention enables people to tag things that are inappropriate. Those items are flagged and examined by academic personnel and taken down if necessary. This same embodiment removes content if it is not free of permissions issues. The removed content is linked to a notification email that goes out to the offending author(s). A message for this person also appears on his or her home page. There are no limits on the purposes or the content of the files that are published, except: the materials must potentially serve legitimate educational needs or whatever need the user had tailored an embodiment of the present invention for; the person publishing the materials must affirm that all of the content is original or that necessary copyright permissions have been obtained; and the user must follow any applicable size restrictions.

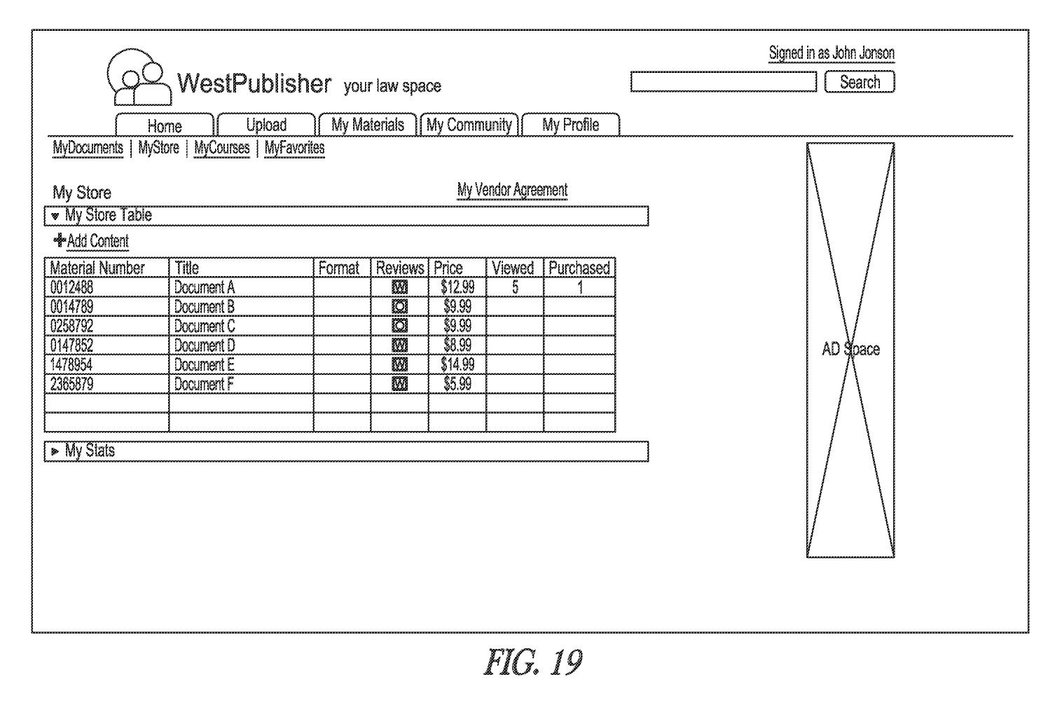

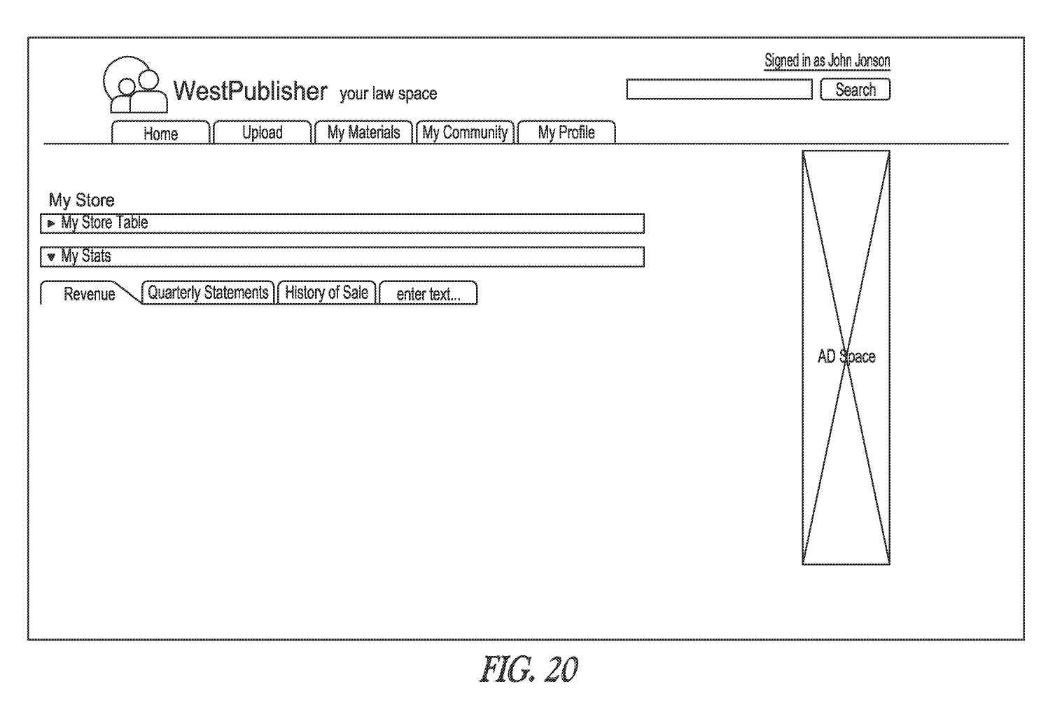

FIG. 19 shows an exemplary My Store interface that lists what the author has uploaded for purchase, and is displayed in response to user selection of a Mysore tab. This table includes material number, title, format, reviews, price, number of people that viewed the material, number of people that purchased material. This screen also gives the author, in this example, the ability to add content by selecting the link “Add Content.” A link to the vendor's agreement, labeled My Vendor Agreement is also located on this section of the webpage. Underneath the table of materials is a link to a statistics sections, labeled My Stats. Selection of this link invokes display of an exemplary statistics interface shown in FIG. 20, where the user can see his or her revenue, history of sale, and timely statements.

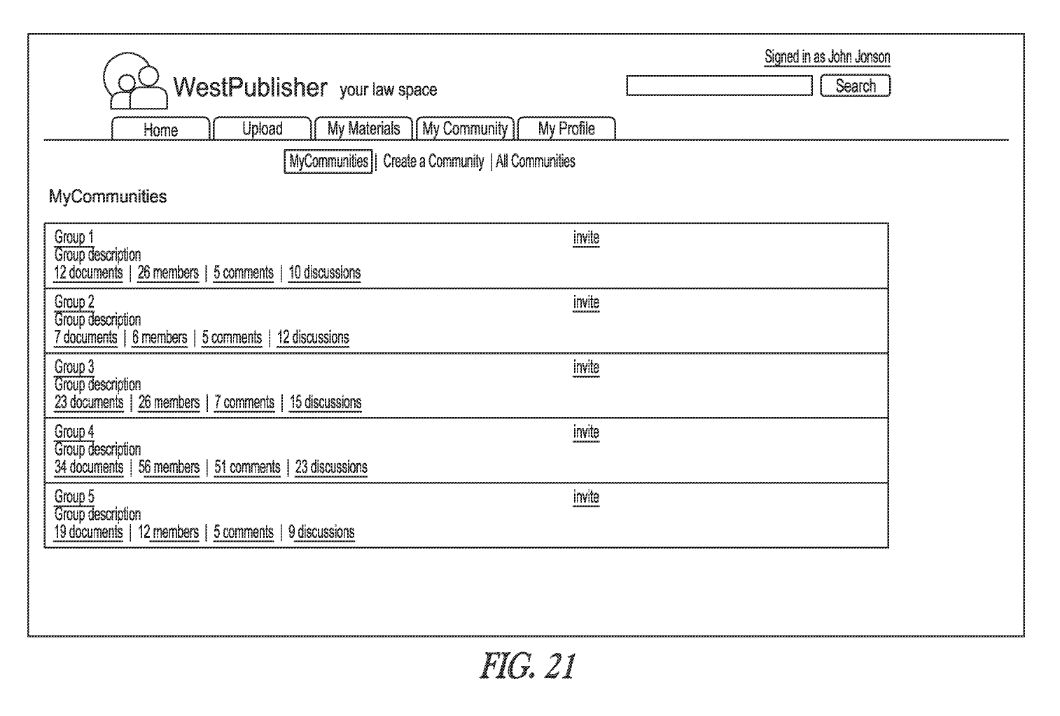

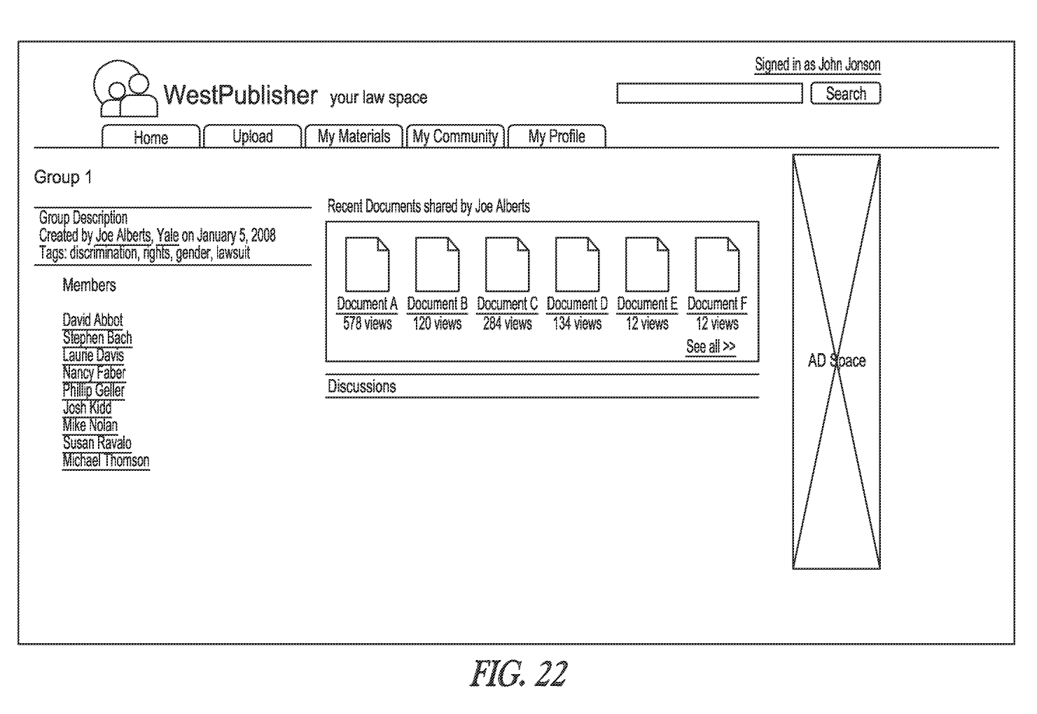

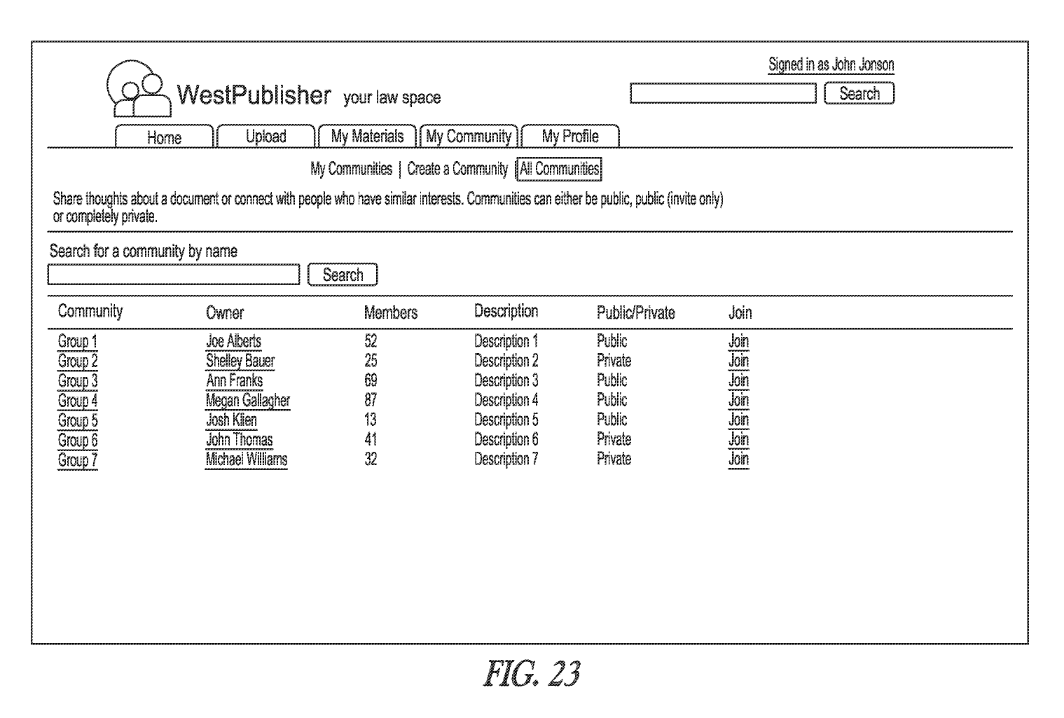

FIG. 21 shows an exemplary My Communities interface which is displayed in response to selection of the My Communities tab. Displayed is a listing of the communities the user is connected to. Each group listing includes a group description, number of members within the group, number of comments to the group, number of discussions, and number of documents posted within the group. The user can select the group name for more detailed information including membership, all shared documents, discussions, if the user has access to the community. FIG. 22 shows an exemplary interface with detailed information for group 1. In FIG. 21, also included with each group listing is an “Invite” link that allows a community member to invite non-members to join the group. In addition to the listing of groups or communities, the My Communities interface allows the user to create a community or to see a listing of all communities within the system via selection of the All Communities link or the Create a Community links. Selection of the All Communities link invokes display of the interface shown in FIG. 23.

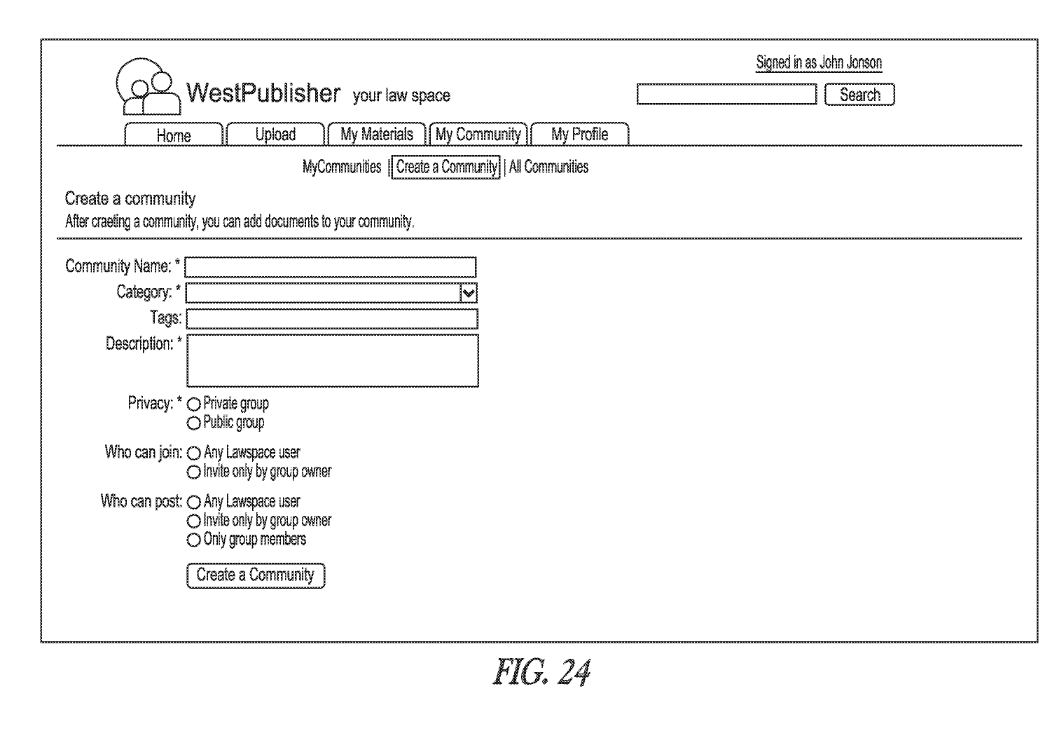

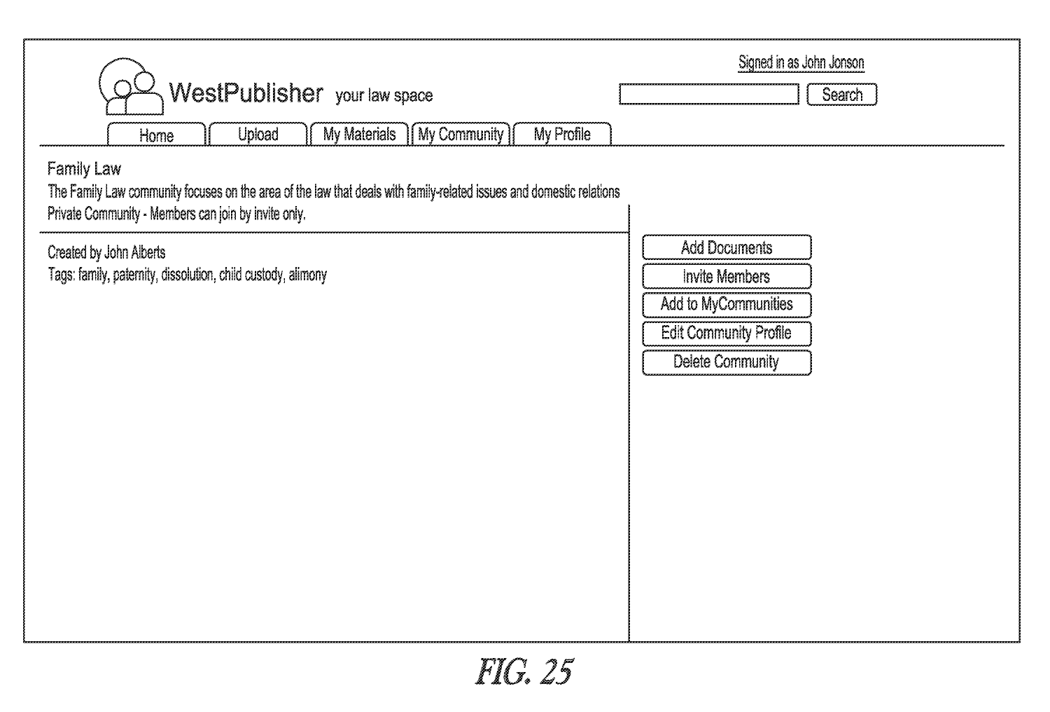

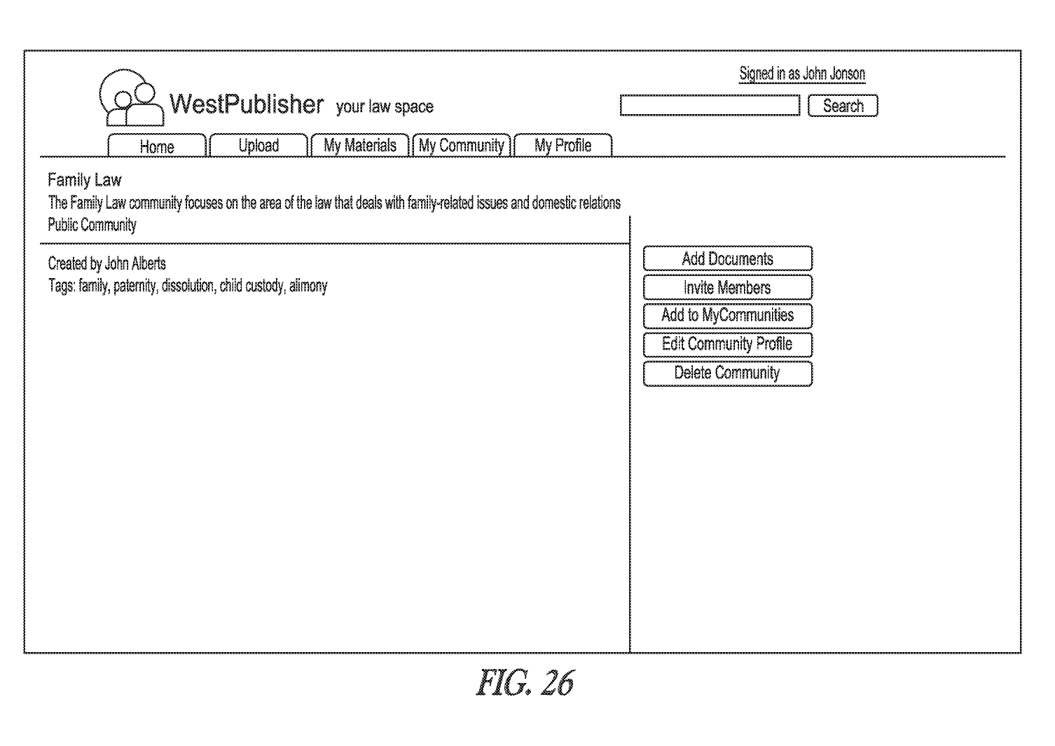

Selection of the Create a Community link invokes display of the interface shown in FIG. 24, which walks the user through creating a community profile including defining a name, description, and membership and accessibility information. Once the community group information is entered, the user selects the “create a community” command button. In response to creation of a private community, the interface in FIG. 25 is displayed, and in response to creation of a public community the interface in FIG. 26 is displayed. These two interfaces permit the user to select buttons that add documents, invite members, add to My Communities tab, edit community profile, and delete community.

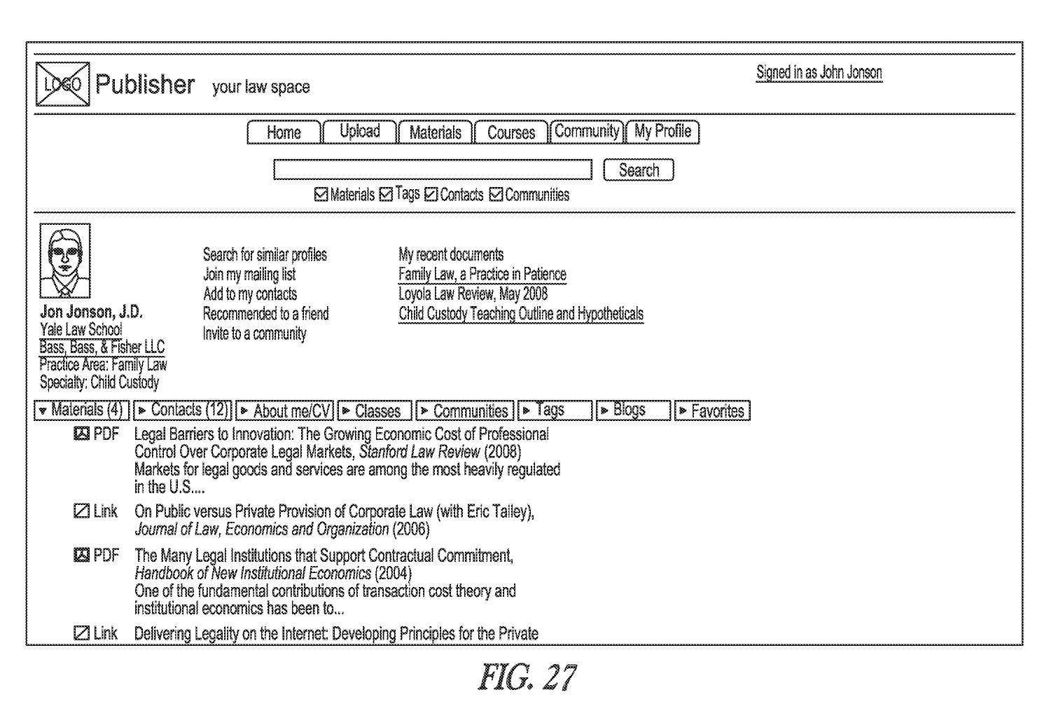

FIG. 27 shows an exemplary My Profile interface that allows the user to see a detailed, concise illustration of the information about himself. Some of the information comes from when the user inputted the information during initial registration. Additional information could be accessed through TWEN® or other proprietary sources and populated into the profile section. For example, some embodiments access information from social networking sites, such as the Facebook and/or LinkedIn websites. Some of the identifying characteristics of the users come from add-ons such as a Westlaw® password, administrator designations (whether some one is from an AALS member school or not). Having identifiable characteristics allows for segmentation of users and creation of sub-communities within the larger educational publishing website community. An example of a sub-community is the reproduction of the AALS directory through the website. Each individual has a profile that extends and the data held within the current AALS directory promotes that community and access to those community members through the website.

If student access is granted at a personal user level it is possible to envision student organizations using educational publishing website for communication and distribution of materials (Law Reviews and Journals being a natural user group). Networks would also include school level networks, student org. level networks, subject matter networks, adjunct networks. With the individual profiles and connections to members through the educational publishing website, the system would eventually need to house community mechanisms. Components of the community aspect of this site include tools such as threaded forums and live chat. By providing these mechanisms, site users have the ability to communicate with their peers in synchronous and asynchronous manners which foster relationships. Guidelines on how to participate and a user agreement to protect all parties are also included within the community mechanism.

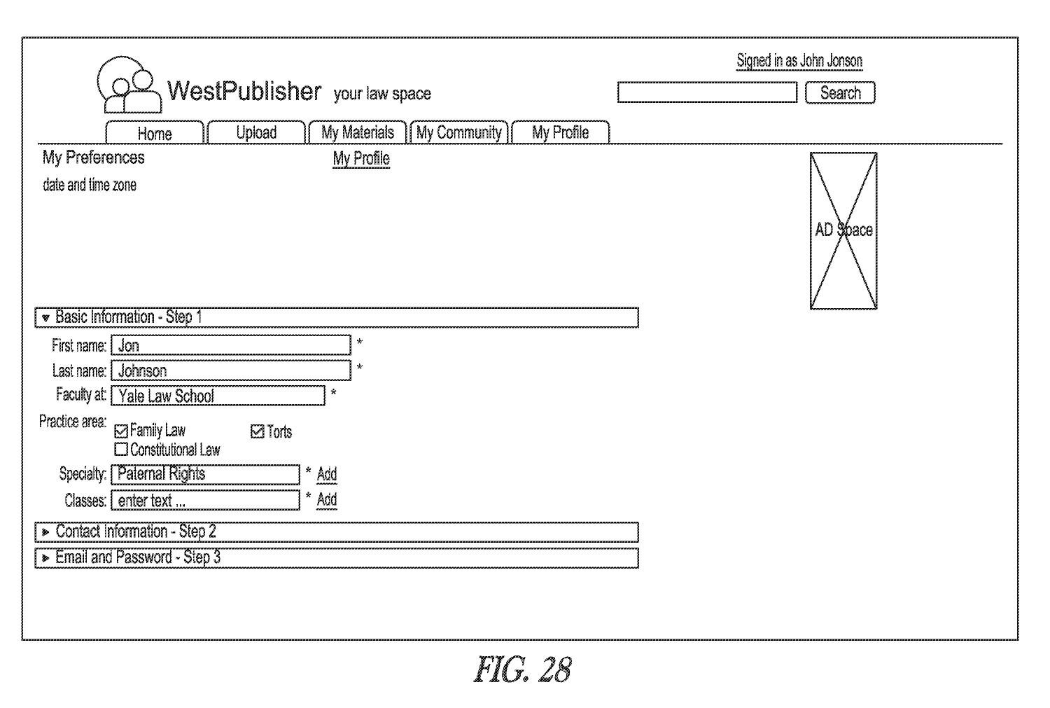

Back to individual user profiles in FIG. 27, a profile can include photo, educational information, area of expertise, specialties. The profile also includes information about their profile within the scope of the system including but limited to number of contacts, number of groups of which he or she is a member, number of documents uploaded, number of courses, and number of requests for contacts. At the screen, the user can access tabs showing documents uploaded, his or her resume or CV, classes attending/instructing, list of contacts and their information. Also within the page, is a My Preferences link or button, which upon selection invokes of display of the My Preferences interface shown in FIG. 28.

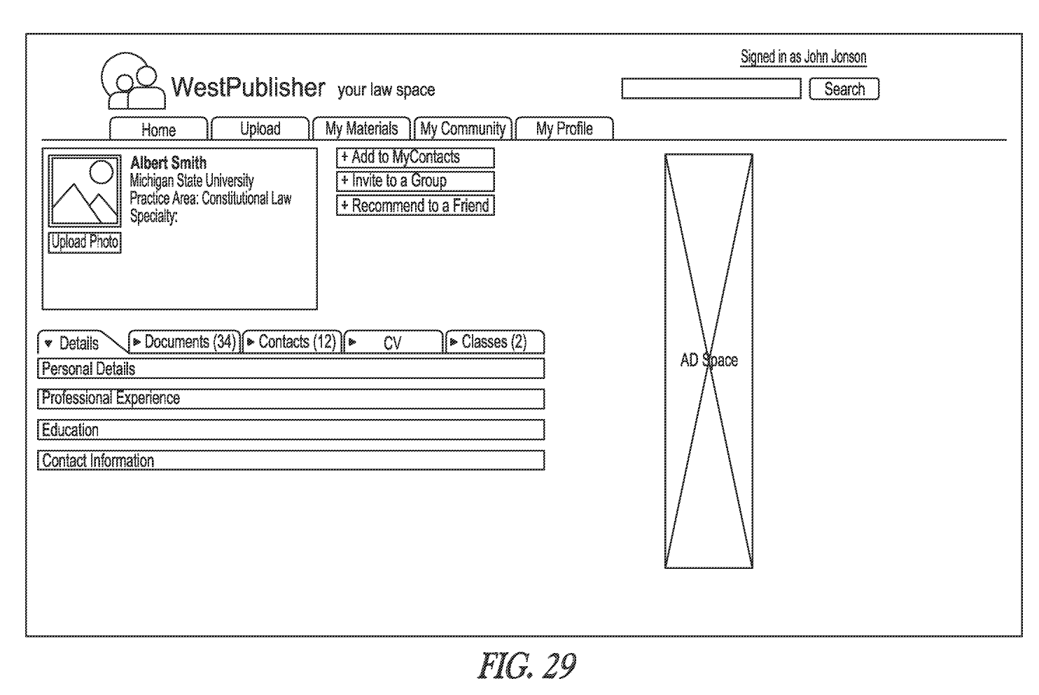

The My Preferences interface enables the user to change any information he or she entered during registration or a previous updating session. Another feature allows the user to edit his or her profile without a My Preferences link. This feature permits editing directly on the profile page, as shown on the interfaces depicted in FIGS. 29-31.

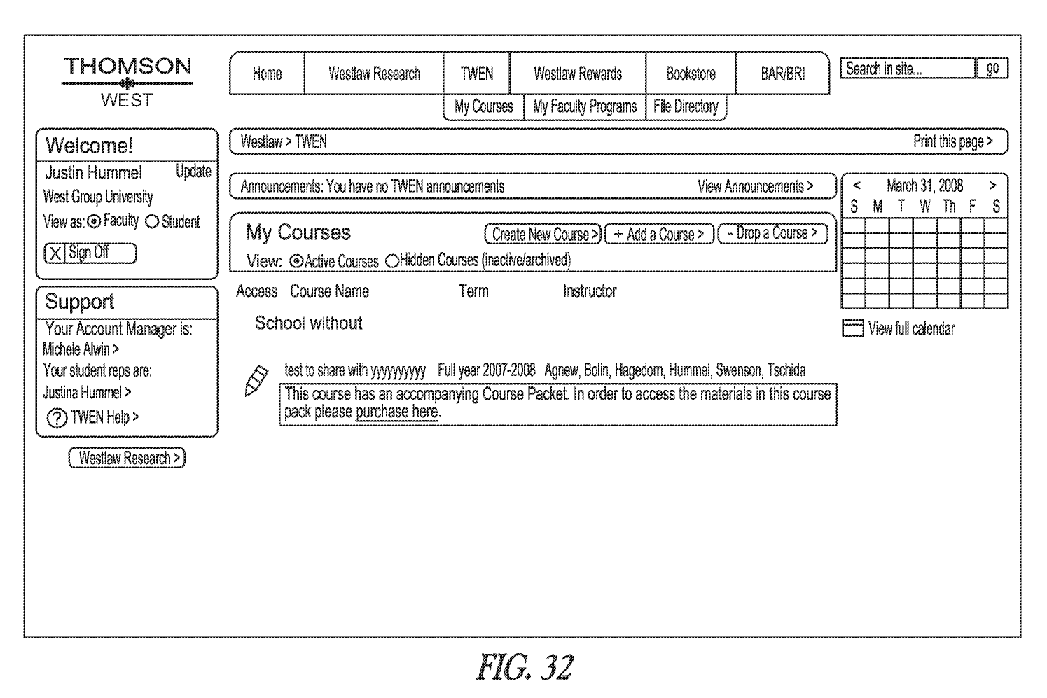

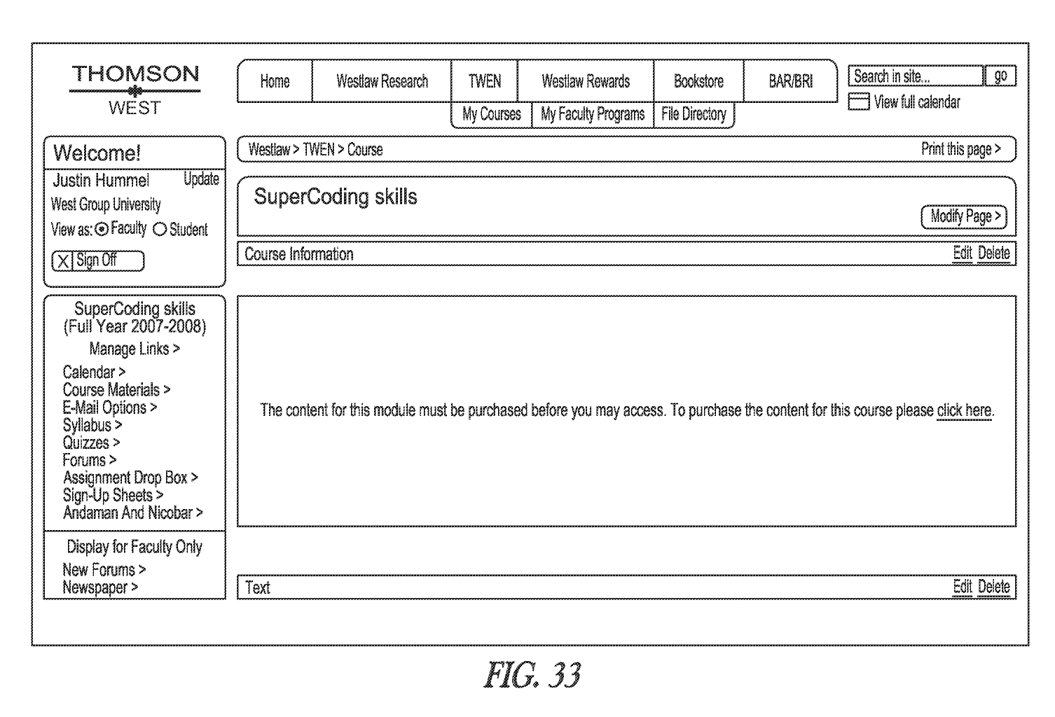

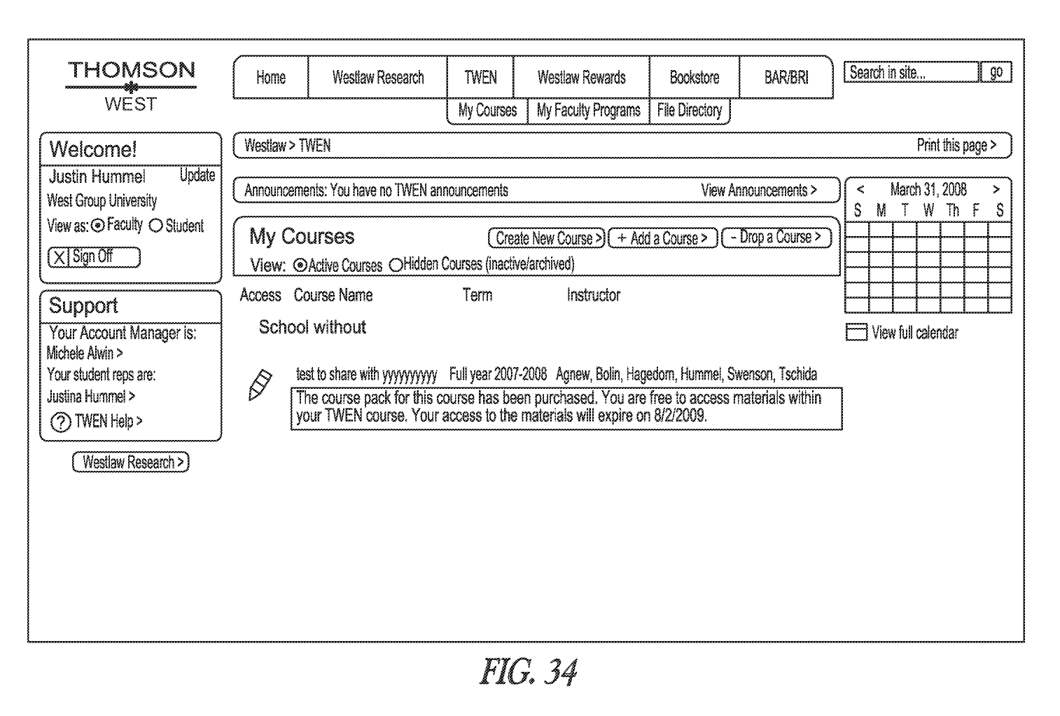

The students purchase the course pack material through the TWEN® website. FIGS. 32-33 demonstrate the user being provided a link to conduct an e-commerce transaction for a course pack from My Courses or content for course pack under Super Coding skills, respectively. Once the e-commerce transaction has been completed, FIG. 34 notifies the user the transaction was successful and when access to the materials expires. The expiration date can be set by the professor.

An embodiment includes the use of “Credit Cards” or point cards which could be issued at law school bookstores. These cards allow the user to purchase credits that could be redeemed for products. This idea would allow us to provide access to content through some sort of key-code or unlocking number. An administrative tool for providing free access to the content would fall under the purview of the super-user.

A further embodiment of the present invention takes into account versioning of the currently posted materials. Each material has a special ID tied to it. The IDs allow the author to tie the original material to updated materials. This occurs at the time of adding materials to the system. The user would be able to go into a library of previously posted materials and add a number of items this new item is an update to.

Another embodiment of the present invention provides a user with an adoptable class/course. The adoptable course includes everything the teacher would need to conduct a lecture on a particular topic or curriculum. For example, a professor is a Constitution Law expert but he has been instructed to pick up and teach an Ethics course. The adoptable course would provide that teacher with all the materials to teach the class including student course materials, teaching guidelines, course curriculum, tests, quizzes, and assignments and some other administrative materials as well such as grading sheet, seating chart, list of students. The adoptable course can be constructed by the department faculty, an expert in the field, the dean, or any entity that the university or school deems has the expertise. In addition, the adoptable course provides a consistency and comfort that several courses on the same topic are being taught the exact same curriculum.

### Exemplary System Platform

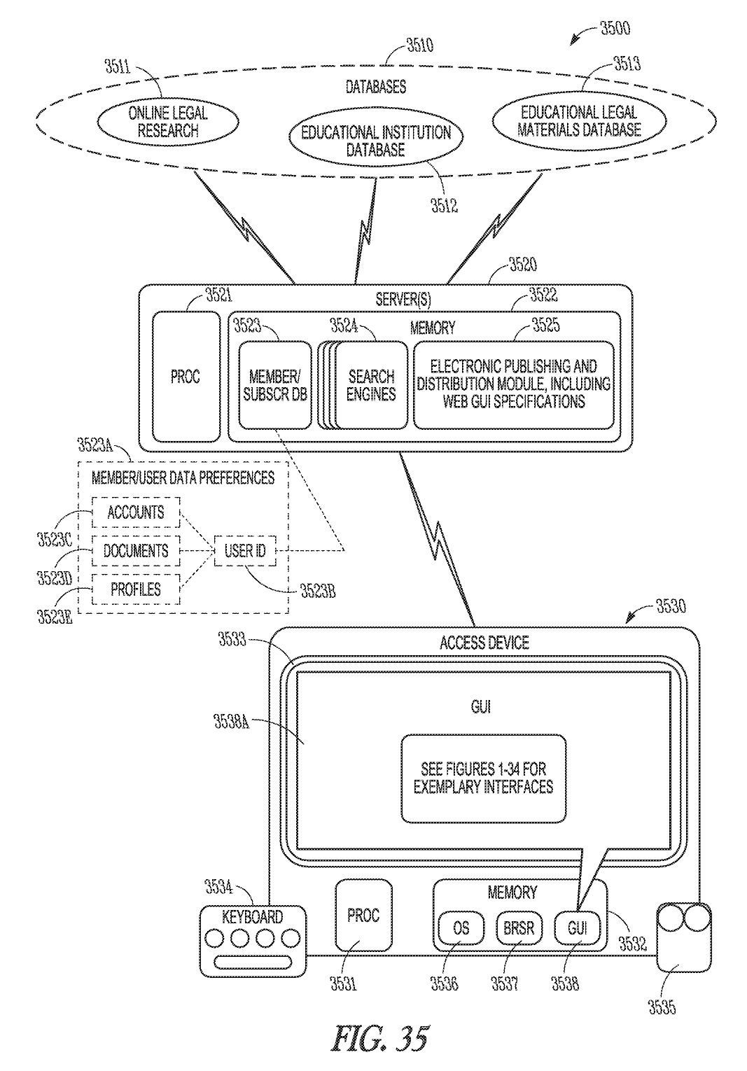

FIG. 35 shows an exemplary system platform 3500 which incorporates the interfaces and associated functionality described above. System 3500 includes one or more databases 3510, one or more servers 3520, and one or more access devices 3530.

### Exemplary Databases

Databases 3510 include a set of one or more databases. In the exemplary embodiment, the set includes an online legal research database 3511, an educational institution database 3512, an educational materials database 3513, and one or more other databases to support the functionality described herein.

Databases 3510, which take the exemplary form of one or more electronic, magnetic, or optical data-storage devices, include or are otherwise associated with respective indices (not shown). Each of the indices includes terms and/or phrases in association with corresponding document addresses, identifiers, and other information for facilitating the functionality described below. Databases 3510 are coupled or couplable via a wireless or wireline communications network, such as a local-, wide-, private-, or virtual-private network, to server 3520.

### Exemplary Server

Server 3520, which is generally representative of one or more servers for serving data in the form of webpages or other markup language forms with associated applets, ActiveX controls, remote-invocation objects, or other related software and data structures to service clients of various “thicknesses.” More particularly, server 120 includes a processor 121, a memory 122, a subscriber database 123, one or more search engines 124 and interface module 125.

Processor 3521, which is generally representative of one or more local or distributed processors or virtual machines, is coupled to memory 3522. Memory 3522, which takes the exemplary form of one or more electronic, magnetic, or optical data-storage devices, stores member or subscriber database 3523, search engines 3524, and electronic publishing and distribution module 3525.

Member or subscriber database 3523 includes member or subscriber data for controlling, administering, and managing electronic publishing and distribution of educational materials as described herein.

In the exemplary embodiment, member database 3523 includes one or more data structures, of which data structure 3523A is representative. Data structure 3523A includes a customer or user identifier portion 3523B, which is logically associated with data elements or fields, such as fields 3523C, 3523D, and 3523E. Field 3523C includes information such as a user password and/or information identifying one or more user accounts, such as the educational publishing and distribution account, educational institution database accounts, financial accounts, and so forth. Fields 3523D includes one or more documents and associated rights and other metadata, for example, documents and associated metadata regarding the pricing of the documents and to whom the document may be offered, who has purchased or downloaded the documents, who the buyers and adopters are, ratings, and reviews of the documents, publication and transactional history of the documents. It also included information for documents purchased or downloaded by the corresponding user, as well as other information necessary to work with documents published and/or distributed by the exemplary system. Fields 3523E includes profile and preference and member home page information for implementing the system as described herein.

Search engines 3524 provide Boolean or natural-language search capabilities for databases 3510. Additionally, search engines 3524 includes a result extension capability, such as that described in copending U.S. patent application Ser. No. 11,028,476 which suggests alternative relevant documents.

Electronic publishing and distribution module 3525, which, among, other things defines one or portion of the graphical user interfaces shown and/or described above with aid of FIGS. 1-34. Module 3525 includes one or more browser-compatible applets, webpage templates, user-interface elements, objects or control features or other programmatic objects or structures.

Server 3520 is communicatively coupled or couplable via a wireless or wireline communications network, such as a local-, wide-, private-, or virtual-private network, to one or more accesses devices, such as access device 3530.

### Exemplary Access Device

Access device 3530 is not only communicatively coupled or couplable to server 3530, but also generally representative of one or more access devices. In the exemplary embodiment, access device 3530 takes the form of a personal computer, workstation, personal digital assistant, mobile telephone, or any other device capable of providing an effective user interface with a server or database.

Specifically, access device 3530 includes one or more processors (or processing circuits) 3531, a memory 3532, a display 3533, a keyboard 3534, and a graphical pointer or selector 3535. Memory 3532 stores code (machine-readable or executable instructions) for an operating system 3536, a browser 3537, a graphical user interface 3538 which provides functionality as further shown and described herein. In the exemplary embodiment, operating system 3536 takes the form of a version of the Microsoft Windows operating system, and browser 3537 takes the form of a version of Microsoft Internet Explorer. GUI 3538 include the interface definitions for cooperating with operating system 3536 and browser 3537 to implement the interfaces and associated functionality shown and/or described with aid of FIGS. 1-34.

### CONCLUSION

The embodiments described above are intended only to illustrate and teach one or more ways of making and using the present invention, not to restrict its breadth or scope. The actual scope of the invention, which embraces all ways of practicing or implementing the teachings of the invention, is defined only by one or more issued patent claims and their equivalents.

What is claimed is:

1. A system comprising:
graphical user interfacing means for allowing an author to self-publish at least one legal educational document for electronic distribution on a legal educational website; and
means for allowing access to the one legal educational document by a user for the designated amount.

2. The system of claim 1, wherein the graphical user interfacing means includes means for allowing the author to specify the designated amount and to specify a set of users who may access the one legal educational document.

3. The system of claim 1, further comprising means for allowing a user to adopt and promote usage of the one legal educational document to other users who are enrolled in a class instructed by the user.

4. The system of claim 1, further comprising means for enabling a user to define a home page including professional information regarding the user.

5. The system of claim 1, further comprising means for enabling a user to post a review of the one legal educational document.

6. The system of claim 1, further comprising means for the author to access and review a listing of courses associated with the author.
